(19) United States
(12) Patent Application Publication
(10) Pub. No.: US 2008/0225027 A1
(43) Pub. Date: Sep. 18, 2008

(54) Pixel circuit, display device, and driving method thereof

(75) Inventors: Naobumi Toyomura, Kanagawa (JP); Katsuhide Uchino, Kanagawa (JP); Yukihito Iida, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/073,893

(22) Filed: Mar. 11, 2008

(30) Foreign Application Priority Data
Mar. 16, 2007 (JP) 2007-068020

(51) Int. Cl. G06F 3/038

(52) U.S. Cl. 345/204

(57) ABSTRACT

Disclosed herein is a display device including a pixel array unit and a control unit.

### CROSS REFERENCES TO RELATED APPLICATIONS

The present invention contains subject matter related to Japanese Patent Application JP 2007-068020 filed in the Japan Patent Office on Mar. 16, 2007, the entire contents of which being incorporated herein by reference.

### BACKGROUND OF THE INVENTION

1. Field of the Invention

The present invention relates to a pixel circuit (referred to also as a pixel) including an electro optic element (referred to also as a display element or a light emitting element), a display device having a pixel array unit in which such pixel circuits are arranged in the form of a matrix, and a driving method of the display device, and particularly to a pixel circuit having an electro optic element changing in luminance according to the magnitude of a driving signal as a display element, an active matrix type display device that is formed by arranging such pixel circuits in the form of a matrix and which device has an active element in each pixel circuit, display driving being performed in a pixel unit by the active element, and a driving method of the active matrix type display device.

2. Description of the Related Art

There are display devices that use an electro optic element changing in luminance according to a voltage applied to the electro optic element or a current flowing through the electro optic element as a display element of a pixel. For example, a liquid crystal display element is a typical example of an electrooptic element that changes in luminance according to a voltage applied to the electrooptic element, and an organic electroluminescence (hereinafter described as organic EL) element (organic light emitting diode (OLED)) is a typical example of an electrooptic element that changes in luminance according to a current flowing through the electrooptic element. An organic EL display device using the latter organic EL element is a so-called emissive display device using a self-luminous electrooptic element as a display element of a pixel.

The organic EL element is an electrooptic element using a phenomenon of light emission on application of an electric field to an organic thin film. The organic EL element can be driven by a relatively low application voltage (for example 10V or lower), and thus consumes low power. In addition, the organic EL element is a self-luminous element that emits light by itself, and therefore obviates a need for an auxiliary illuminating member such as a backlight desired in a liquid crystal display device. Thus the organic EL element can be easily reduced in weight and thickness. Further, the organic EL element has a very high response speed (for example a few μs or so), so that no afterimage occurs at a time of displaying a moving image. Because the organic EL element has these advantages, flat-panel emissive display devices using the organic EL element as an electrooptic element have recently been actively developed.

In a current-driven type electrooptic element typified by the organic EL element, a different driving current value means a different light emission luminance. Hence, for light emission at stable luminance, it is important to supply stable driving current to the electrooptic element. For example, driving systems for supplying driving current to the organic EL element can be roughly classified into constant-current driving systems and constant-voltage driving systems (the systems are well known techniques, and therefore publicly known documents thereof will not be presented).

Because the voltage-current characteristic of the organic EL element has a steep slope, when constant-voltage driving is performed, slight variations in voltage or variations in element characteristic cause great variations in current and thus bring about great variations in luminance. Hence, constant-current driving in which a drive transistor is used in a saturation region is generally used. Of course, even with constant-current driving, changes in current invite variations in luminance. However, small variations in current cause only small variations in luminance.

Conversely, even with the constant-current driving system, in order for the light emission luminance of an electrooptic element to be unchanged, it is important for a driving signal written to a storage capacitor according to an input image signal and retained by the storage capacitor to be constant. For example, in order for the light emission luminance of an organic EL element to be unchanged, it is important for a driving signal corresponding to an input image signal to be constant.

However, the threshold voltage and mobility of an active element (drive transistor) driving the electrooptic element vary due to process variations. In addition, characteristics of the electrooptic element such as the organic EL element or the like vary with time. Variations in the characteristics of the active element for such driving and variations in the characteristics of the electrooptic element affect light emission luminance even in the case of the constant-current driving system.

Thus, various mechanisms for correcting luminance variations caused by variations in the characteristics of the active element for the above-described driving and the electrooptic element within each pixel circuit are being studied to uniformly control the light emission luminance over the entire screen of a display device.

For example, a mechanism described in Japanese Patent Laid-Open No. 2006-215213 (hereinafter referred to as Patent Document 1) as a pixel circuit for an organic EL element has a threshold value correcting function for holding the driving current constant even when there is a variation or a secular change in threshold voltage of the drive transistor, a mobility correcting function for holding the driving current constant even when there is a variation or a secular change in mobility of the drive transistor, and a bootstrap function for holding the driving current constant even when there is a secular change in current-voltage characteristic of the organic EL element.

### SUMMARY OF THE INVENTION

However, in the mechanism described in Patent Document 1, a mobility correcting period begins with a sampling transistor remaining on after the sampling transistor is turned on to retain a driving potential corresponding to a video signal in a storage capacitor. Thus, because mobility correcting operation is performed in a state of the gate potential of the drive transistor being fixed, gate-to-source voltage is decreased due to mobility correction, which results in an adverse effect of a decrease in light emission luminance when no measure is taken against the decrease in the gate-to-source voltage.

As a method for preventing the decrease in the light emission luminance which decrease is caused by the mobility correction, for example, a video signal of larger magnitude may be supplied to write a driving potential to the storage capacitor so as to compensate for the decrease in the gate-to-source voltage due to the mobility correction. However, this method needs to increase the amplitude of the video signal as compared with a case where the mobility correction is not made. It is thus necessary to increase power supply voltage and the magnitude of a writing driving pulse, which leads to an increase in voltage consumption.

The present invention has been made in view of the above-described situation. It is desirable to provide a mechanism that can prevent a decrease in light emission luminance which decrease is caused by mobility correction without increasing the amplitude of a video signal.

An embodiment of a display device according to the present invention is a display device that makes an electrooptic element within a pixel circuit emit light on a basis of a video signal. Each of pixel circuits arranged in the form of a matrix in a pixel array unit includes at least a drive transistor for generating a driving current, an electrooptic element connected to an output terminal of the drive transistor, a storage capacitor for retaining information (driving potential) corresponding to the signal potential of the video signal, and a sampling transistor for writing information corresponding to the signal potential of the video signal to the storage capacitor. In this pixel circuit, the drive transistor generates the driving current based on the information retained by the storage capacitor and passes the driving current through the electrooptic element, whereby the electrooptic element emits light.

The sampling transistor writes the information corresponding to the signal potential as a driving potential to the storage capacitor. Thus, the sampling transistor takes in the signal potential at an input terminal thereof (one of a source terminal and a drain terminal), and then writes the information corresponding to the signal potential to the storage capacitor connected to an output terminal thereof (the other of the source terminal and the drain terminal). Of course, the output terminal of the sampling transistor is also connected to a control input terminal of the drive transistor.

It is to be noted that the connection configuration of the pixel circuit shown above is a most basic configuration, and that it suffices for the pixel circuit to include at least the above-described constituent elements and the pixel circuit may include other than these constituent elements (that is, other constituent elements). In addition, “connection” is not limited to direct connection, and may be connection via another constituent element.

For example, a change may be made as occasion demands such that a switching transistor, a functional unit having a certain function, or the like is further interposed between connections. Typically, a switching transistor (light emission controlling transistor) for dynamically controlling a display period (an emission period in other words) may be disposed between the output terminal of the drive transistor and the electrooptic element or between the power supply terminal (drain terminal in a typical example) of the drive transistor and a power supply line as wiring for power supply.

Pixel circuits in such modification modes are also pixel circuits for realizing an embodiment of the display device according to the present invention as long as the pixel circuits can realize the constitution and action described in this section (measures for solving the problems).

In this case, as a characteristic point of an embodiment of the pixel circuit and the display device according to the present invention, with the pixel circuit as a basis, a capacitive element having one terminal connected to the output terminal of the drive transistor and having another terminal supplied with a pulse signal is provided in each pixel circuit. The other terminal of the capacitive element is supplied with the pulse signal for starting a mobility correcting operation. The output terminal of the drive transistor is thereby supplied via the capacitive element with transition information in a direction of increasing a potential difference between the control input terminal and the output terminal of the drive transistor. Thus, mobility correction can be made after the potential difference between the control input terminal and the output terminal of the drive transistor is widened at the time of a start of the mobility correction.

The pulse signal for starting the mobility correcting operation which pulse signal is supplied to the other terminal of the capacitive element can be various according to the configuration of the pixel circuit and driving timing. For example, in the case of a 5TR configuration as described in Patent Document 1 which configuration includes a drive transistor and a sampling transistor as well as two switch transistors performing on/off operation on the basis of a control pulse at the time of threshold value correcting operation or mobility correcting operation and a light emission controlling transistor for adjusting the duty of an emission period, when the mobility correcting operation is performed in a period in which a writing driving pulse supplied to the sampling transistor and a scanning driving pulse supplied to the light emission controlling transistor are both active, the scanning driving pulse supplied to the control input terminal of the light emission controlling transistor is preferably set as the pulse for starting the mobility correcting operation.

Further, in this case, when the power supply terminal side of the drive transistor of one of an n-type and a p-type is provided with the light emission controlling transistor of the other of the n-type and the p-type, it suffices to connect the other terminal of the capacitive element to the control input terminal of the light emission controlling transistor and supply the scanning driving pulse to the other terminal.

Of course, this is one example, and it suffices to connect one terminal of the capacitive element to the output terminal of the drive transistor, the output terminal being the electrooptic element side of the drive transistor, and supply the information corresponding to the pulse for starting the mobility correcting operation to the other terminal of the capacitive element to thereby supply transition information of the pulse (especially information in a direction of widening a gate-to-source voltage of the drive transistor at a start of the mobility correction) to the output terminal of the drive transistor.

According to an embodiment of the present invention, the capacitive element is added, and one terminal of the capacitive element is connected to the output terminal of the drive transistor and the other terminal of the capacitive element is supplied with the information corresponding to the pulse for starting the mobility correcting operation. Thereby the potential difference between the control input terminal and the output terminal of the drive transistor is increased.

When the sampling transistor is set in a conducting state to retain the information corresponding to the signal potential in the storage capacitor and then mobility correcting operation is performed while the sampling transistor is held in the conducting state, mobility correction can be made after the potential difference between the control input terminal and the output terminal of the drive transistor is widened in advance at the time of a start of the mobility correction. It is therefore possible to compensate for a decrease in the potential difference between the control input terminal and the output terminal of the drive transistor due to the mobility correction.

As a result, the driving potential during the emission period can be widened. It is therefore possible to prevent a decrease in light emission luminance which decrease is caused by the mobility correction without increasing the amplitude of the video signal. Because the amplitude of the video signal does not need to be increased, it is also possible to contribute to a reduction in power consumption.

### BRIEF DESCRIPTION OF THE DRAWINGS

FIG. 1 is a block diagram schematically showing a configuration of an active matrix type display device as an embodiment of a display device according to the present invention;

FIG. 2 is a diagram showing a comparison example for a pixel circuit P according to the present embodiment forming the organic EL display device shown in FIG. 1;

FIG. 3 is a diagram of assistance in explaining an operating point of an organic EL element and a drive transistor;

FIGS. 4A to 4C are diagrams of assistance in explaining effects of characteristic variations of the organic EL element and the drive transistor on driving current Ids;

FIG. 5 is a diagram (1) of assistance in explaining a concept of a method for remedying the effects of characteristic variations of the drive transistor on the driving current;

FIGS. 6A to 6D are diagrams (2) of assistance in explaining the concept of the method for remedying the effects of characteristic variations of the drive transistor on the driving current;

FIG. 7 is a timing chart of assistance in explaining operation of a pixel circuit of a second comparison example;

FIG. 8 is a diagram showing a pixel circuit P according to the present embodiment and an embodiment of an organic EL display device;

FIG. 9 is a timing chart of assistance in explaining operation of the pixel circuit according to the present embodiment;

FIG. 10 is a diagram of assistance in explaining an operation of correcting a decrease in gate-to-source voltage Vgs due to mobility correction; and

FIG. 11 is a diagram of assistance in explaining operation of a modification example for correcting a decrease in gate-to-source voltage Vgs due to mobility correction.

### DETAILED DESCRIPTION OF THE PREFERRED EMBODIMENTS

Preferred embodiments of the present invention will hereinafter be described in detail with reference to the drawings.

### <General Outline of Display Device>

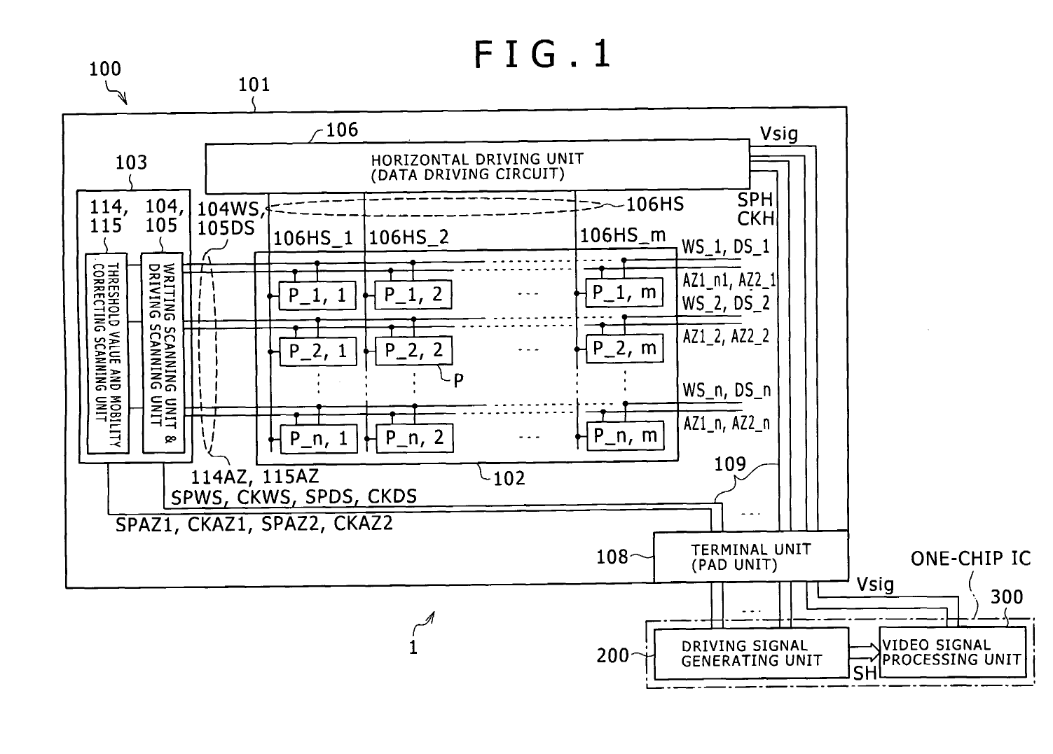

FIG. 1 is a block diagram schematically showing a configuration of an active matrix type display device as an embodiment of a display device according to the present invention. In the present embodiment, description will be made by taking as an example a case where the present invention is applied to an active matrix type organic EL display (hereinafter referred to as an organic EL display device) that for example uses an organic EL element as a display element of a pixel and a polysilicon thin film transistor (TFT) as an active element and which display is constituted with the organic EL element formed on a semiconductor substrate where the thin film transistor is formed.

Incidentally, while concrete description will be made in the following by taking the organic EL element as the display element of the pixel as an example, the organic EL element is an example, and the intended display element is not limited to the organic EL element. All embodiments to be described later are similarly applicable to all light emitting elements that generally emit light by being driven by current.

As shown in FIG. 1, the organic EL display device 1 includes: a display panel unit 100 in which pixel circuits (referred to also as pixels) 110 having organic EL elements (not shown) as a plurality of display elements are arranged so as to form an effective video area having an aspect ratio of X:Y (for example 9:16) as a display aspect ratio; a driving signal generating unit 200 as an example of a panel controlling unit for sending various pulse signals for driving and controlling the display panel unit 100; and a video signal processing unit 300. The driving signal generating unit 200 and the video signal processing unit 300 are included in a one-chip IC (Integrated Circuit).

A product form in which the organic EL display device 1 is provided is not limited to the form of a module (composite part) having all of the display panel unit 100, the driving signal generating unit 200, and the video signal processing unit 300 as shown in FIG. 1. For example, only the display panel unit 100 can be provided as the organic EL display device 1. Such an organic EL display device 1 is used as a display unit in portable type music players using recording media such as semiconductor memories, minidisks (MD), cassette tapes and the like and other electronic devices.

The display panel unit 100 includes for example a pixel array unit 102 in which pixel circuits P are arranged in the form of a matrix of n rows×m columns, a vertical driving unit 103 for scanning the pixel circuits P in a vertical direction, a horizontal driving unit (referred to also as a horizontal selector or a data line driving unit) 106 for scanning the pixel circuits P in a horizontal direction, and a terminal unit (pad unit) 108 for external connection, wherein the pixel array unit 102, the vertical driving unit 103, the horizontal driving unit 106, and the terminal unit (pad unit) 108 are formed in an integrated manner on a substrate 101. That is, peripheral driving circuits such as the vertical driving unit 103, the horizontal driving unit 106 and the like are formed on the same substrate 101 as the pixel array unit 102.

The vertical driving unit 103 includes for example a writing scanning unit (write scanner WS; Write Scan) 104, a driving scanning unit (drive scanner DS; Drive Scan) 105 (the two units are shown integrally with each other in FIG. 1), and two threshold value & mobility correcting scanning units 114 and 115 (the two units are shown integrally with each other in FIG. 1).

The pixel array unit 102 is for example driven by the writing scanning unit 104, the driving scanning unit 105, and the threshold value & mobility correcting scanning units 114 and 115 from one side or both sides in the horizontal direction in FIG. 1, and is driven by the horizontal driving unit 106 from one side or both sides in the vertical direction in FIG. 1. The terminal unit 108 is supplied with various pulse signals from the driving signal generating unit 200 disposed outside the organic EL display device 1. The terminal unit 108 is similarly supplied with a video signal Vsig from the video signal processing unit 300.

For example, necessary pulse signals such as shift start pulses SPDS and SPWS as an example of writing start pulses in the vertical direction and vertical scanning clocks CKDS and CKWS are supplied as pulse signals for vertical driving. In addition, necessary pulse signals such as shift start pulses SPAZ1 and SPAZ2 as an example of threshold value detection start pulses in the vertical direction and vertical scanning clocks CKAZ1 and CKAZ2 are supplied as pulse signals for correcting a threshold value and mobility. Further, necessary pulse signals such as a horizontal start pulse SPH as an example of a writing start pulse in the horizontal direction and a horizontal scanning clock CKH are supplied as pulse signals for horizontal driving.

Each terminal of the terminal unit 108 is connected to the vertical driving unit 103 or the horizontal driving unit 106 via wiring 109. For example, pulses supplied to the terminal unit 108 are internally adjusted in voltage level in a level shifter unit not shown in the figure as occasion demands, and then supplied to respective parts of the vertical driving unit 103 or the horizontal driving unit 106 via a buffer.

The pixel array unit 102 has a constitution in which pixel circuits P each having a pixel transistor provided for an organic EL element as a display element, though not shown in the figure (details will be described later), are two-dimensionally arranged in the form of a matrix, a scanning line is disposed for each row of the pixel arrangement, and a signal line is disposed for each column of the pixel arrangement.

For example, scanning lines (gate lines) 104WS and 105DS, threshold value & mobility correcting scanning lines 114AZ and 115AZ, and a signal line (data line) 106HS are formed in the pixel array unit 102. An organic EL element and a thin film transistor (TFT) for driving the organic EL element, which are not shown in FIG. 1, are formed at a part where the scanning lines and the signal line intersect each other. A combination of the organic EL element and the thin film transistor forms a pixel circuit P.

Specifically, writing scanning lines 104WS_1 to 104WS_n for the n rows driven by a writing driving pulse WS by the writing scanning unit 104 and driving scanning lines 105DS_1 to 105DS_n for the n rows driven by a scanning driving pulse DS by the driving scanning unit 105 as well as threshold value & mobility correcting scanning lines 114AZ_1 to 114AZ_n for the n rows driven by a threshold value & mobility correcting pulse AZ1 by the first threshold value & mobility correcting scanning unit 114 and threshold value & mobility correcting scanning lines 115AZ_1 to 115AZ_n for the n rows driven by a threshold value & mobility correcting pulse AZ2 by the second threshold value & mobility correcting scanning unit 115 are disposed for each pixel row of the pixel circuits P arranged in the form of a matrix.

The writing scanning unit 104 and the driving scanning unit 105 sequentially select each pixel circuit P via the scanning lines 105DS and 104WS on the basis of the pulse signals for a vertical driving system which pulse signals are supplied from the driving signal generating unit 200. The horizontal driving unit 106 writes an image signal to selected pixel circuits P via the signal line 106HS on the basis of the pulse signals for a horizontal driving system which pulse signals are supplied from the driving signal generating unit 200.

Each part of the vertical driving unit 103 scans the pixel array unit 102 on a line-sequential basis and in synchronism with the scanning, the horizontal driving unit 106 writes image signals for one horizontal line in order (that is, in each pixel) in the horizontal direction or simultaneously writes the image signals for one horizontal line to the pixel array unit 102. The former is dot-sequential driving as a whole, while the latter is line-sequential driving as a whole.

When a provision is made for the dot-sequential driving, the horizontal driving unit 106 includes a shift register, a sampling switch (horizontal switch) and the like. The horizontal driving unit 106 writes the pixel signals input from the video signal processing unit 300 to the respective pixel circuits P of a row selected by each part of the vertical driving unit 103 in pixel units. That is, the horizontal driving unit 106 performs the dot-sequential driving in which video signals are written to the respective pixel circuits P of the row selected by vertical scanning in pixel units.

When a provision is made for the line-sequential driving, on the other hand, the horizontal driving unit 106 includes a driver circuit for simultaneously turning on switches not shown in the figure which switches are provided on the signal lines 106HS of all the columns. The horizontal driving unit 106 simultaneously turns on the switches not shown in the figure which switches are provided on the signal lines 106HS of all the columns to simultaneously write the pixel signals output from the video signal processing unit 300 to all the pixel circuits P of one line of the row selected by the vertical driving unit 103.

Each part of the vertical driving unit 103 is formed by a combination of logic gates (including latches), and selects the pixel circuits P of the pixel array unit 102 in row units. Incidentally, while FIG. 1 shows a configuration in which the vertical driving unit 103 is disposed only on one side of the pixel array unit 102, the vertical driving unit 103 can be arranged on both a left side and a right side with the pixel array unit 102 interposed between the left side and the right side.

Similarly, while FIG. 1 shows a configuration in which the horizontal driving unit 106 is disposed only on one side of the pixel array unit 102, the horizontal driving unit 106 can be arranged on both an upper side and a lower side with the pixel array unit 102 interposed between the upper side and the lower side.

### <Pixel Circuit; Comparison Example>

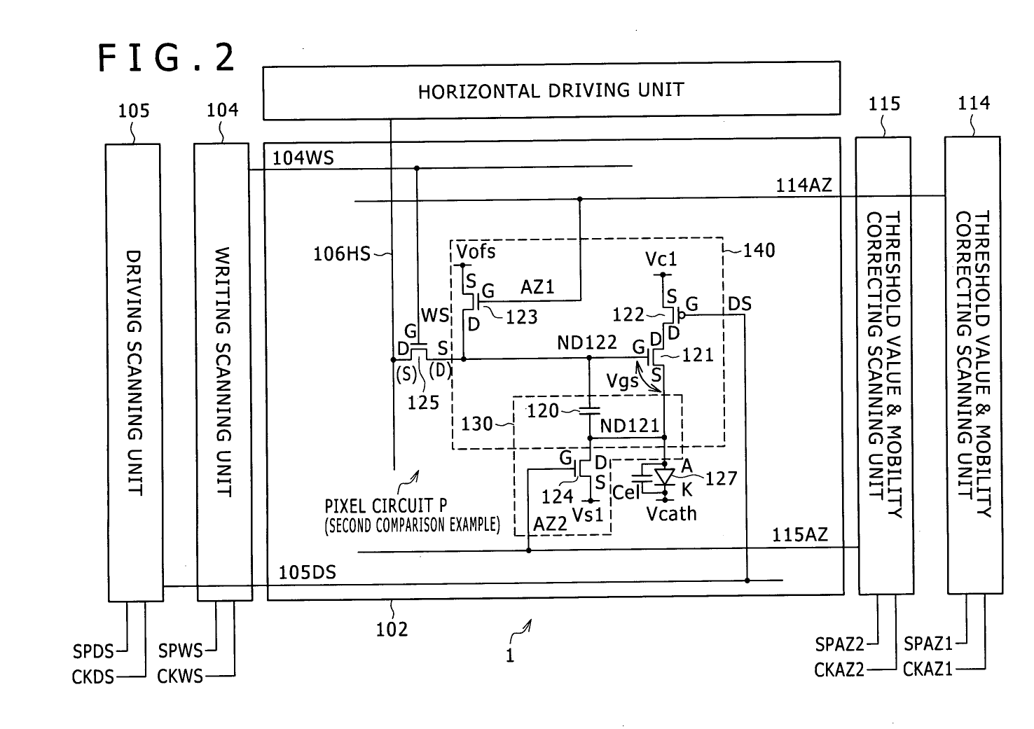

FIG. 2 is a diagram showing a comparison example for a pixel circuit P according to the present embodiment forming the organic EL display device 1 shown in FIG. 1. Incidentally, FIG. 2 also shows the vertical driving unit 103 and the horizontal driving unit 106 provided in a peripheral part on the periphery of the pixel circuits P on the substrate 101 of the display panel unit 100.

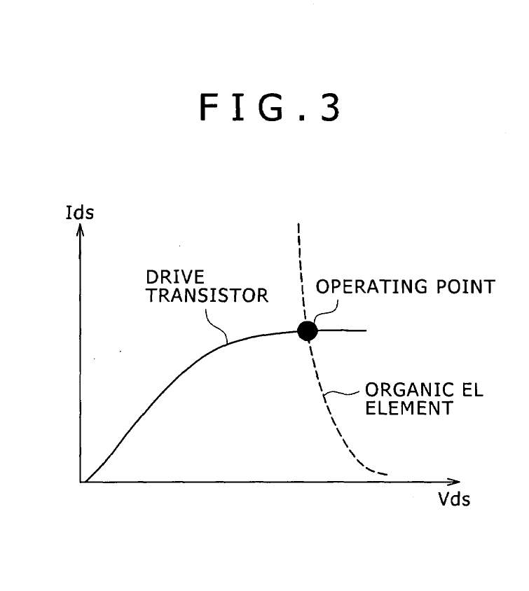

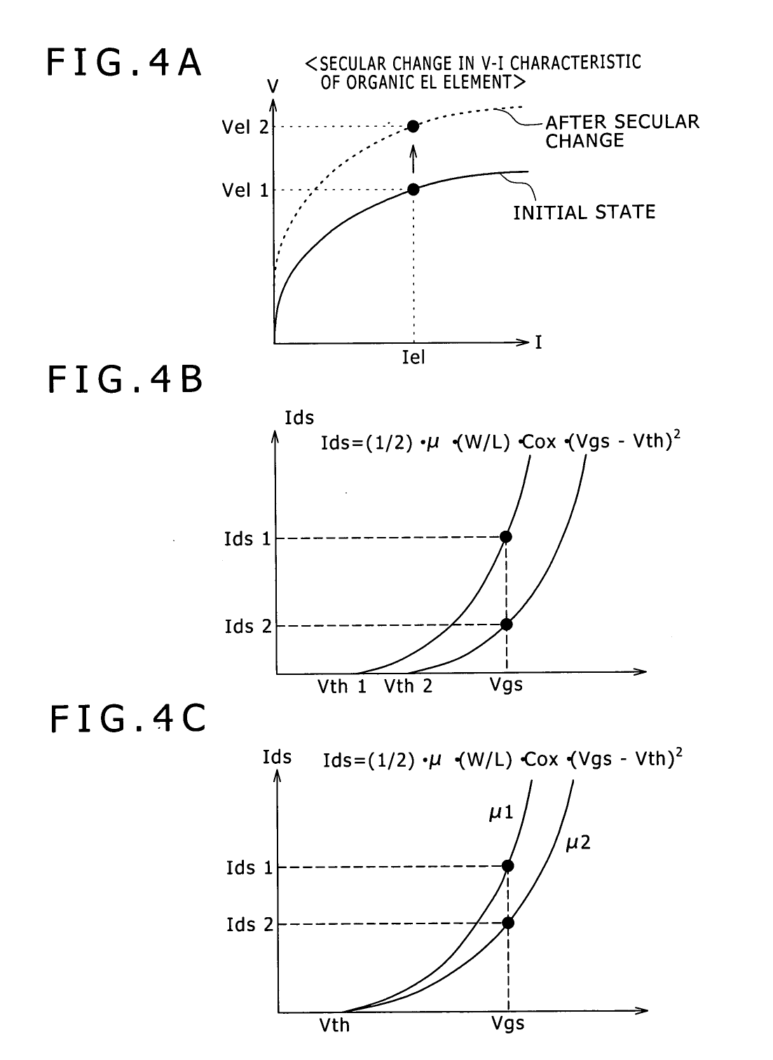

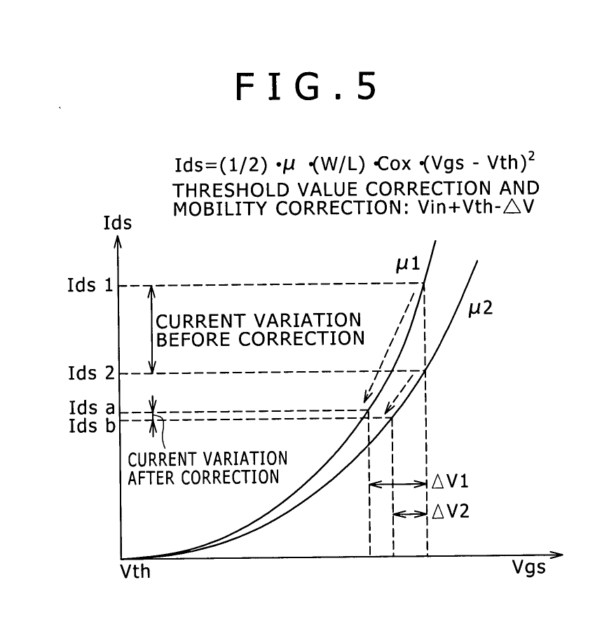

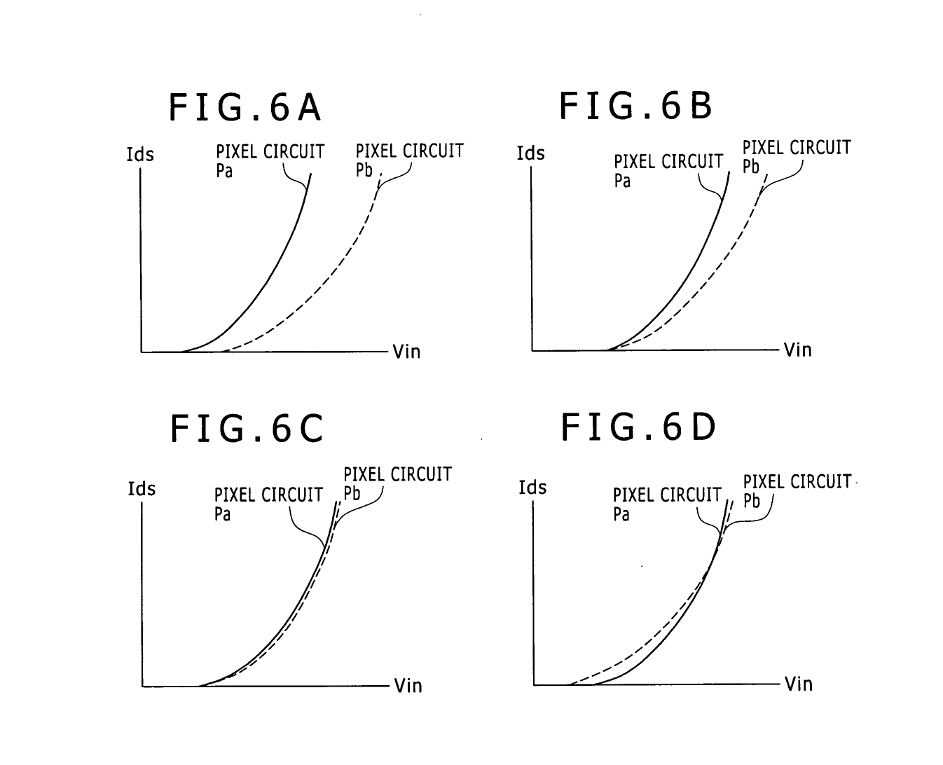

FIG. 3 is a diagram of assistance in explaining an operating point of an organic EL element and a drive transistor. FIGS. 4A to 4C are diagrams of assistance in explaining effects of characteristic variations of the organic EL element and the drive transistor on driving current Ids. FIG. 5 and FIGS. 6A to 6D are diagrams of assistance in explaining a concept of a method of remedying the effects.

The comparison example shown in FIG. 2 and a pixel circuit P according to the present embodiment to be described later basically have a characteristic in that a drive transistor is formed by an n-channel type thin film field effect transistor. The comparison example shown in FIG. 2 and the pixel circuit P according to the present embodiment to be described later have another characteristic in that the comparison example and the pixel circuit P have a circuit for suppressing variations in the driving current Ids supplied to the organic EL element due to secular degradation of the organic EL element, that is, a driving signal uniformizing circuit (1) for correcting changes in current-voltage characteristics of the organic EL element as an example of an electrooptic element and achieving a threshold value correcting function and a mobility correcting function for maintaining the driving current Ids at a constant level. In addition, the comparison example shown in FIG. 2 and the pixel circuit P according to the present embodiment to be described later have a characteristic in that the comparison example and the pixel circuit P have a driving signal uniformizing circuit (2) for achieving a bootstrap function for making the driving current constant even when there is a secular change in the current-voltage characteristics of the organic EL element.

When all the switch transistors can be formed by n-channel type transistors rather than p-channel type transistors, an existing amorphous silicon (a-Si) process can be used in the fabrication of the transistors. Thereby the cost of a transistor substrate can be reduced, and development of the pixel circuit P having such a constitution is anticipated. The comparison example shown in FIG. 2 and the pixel circuit P according to the present embodiment to be described later use a p-type as light emission controlling transistor, which may be a disadvantage.

A MOS transistor is used as each of the transistors including the drive transistor. In this case, the gate terminal of the drive transistor is treated as a control input terminal, one of the source terminal and the drain terminal (the source terminal in this case) of the drive transistor is treated as an output terminal, and the other is treated as a power supply terminal (the drain terminal in this case).

The pixel circuit P of the comparison example shown in FIG. 2 will first be described as a comparison example for describing features of the pixel circuit P according to the present embodiment.

The pixel circuit P of the comparison example includes: a storage capacitor (referred to also as a pixel capacitance) 120; an n-channel type drive transistor 121; a p-channel type light emission controlling transistor 122 whose gate terminal G as control input terminal is supplied with an active-L driving pulse (scanning driving pulse DS); an n-channel type sampling transistor 125 whose gate terminal G as control input terminal is supplied with an active-H driving pulse (writing driving pulse WS); and an organic EL element 127 as an example of an electrooptic element (light emitting element) that emits light while a current flows through the element.

The sampling transistor 125 is a switching transistor provided on the side of the gate terminal G (control input terminal) of the drive transistor 121. The light emission controlling transistor 122 is also a switching transistor.

Generally, the organic EL element 127 has a current rectifying property and is thus represented by the symbol of a diode. Incidentally, the organic EL element 127 has a parasitic capacitance (equivalent capacitance) Ce1. FIG. 2 shows the parasitic capacitance Ce1 in parallel with the organic EL element 127.

The pixel circuit P of the comparison example has characteristics in that the light emission controlling transistor 122 is disposed on the side of the drain terminal D of the drive transistor 121, in that the storage capacitor 120 is connected between the gate and the source of the drive transistor 121, and in that the pixel circuit P has a bootstrap circuit 130 and a threshold value & mobility correcting circuit 140.

Because the organic EL element 127 is a current light emitting element, a color gradation is obtained by controlling an amount of current flowing through the organic EL element 127. Thus, the value of the current flowing through the organic EL element 127 is controlled by changing a voltage applied to the gate terminal G of the drive transistor 121.

At this time, the bootstrap circuit 130 and the threshold value & mobility correcting circuit 140 eliminate effects of a secular change of the organic EL element 127 and characteristic variations of the drive transistor 121. Thus, the vertical driving unit 103 for driving the pixel circuit P includes the two threshold value & mobility correcting scanning units 114 and 115 in addition to the writing scanning unit 104 and the driving scanning unit 105.

While FIG. 2 shows only one pixel circuit P, pixel circuits P having a similar configuration are arranged in the form of a matrix, as described with reference to FIG. 1. The writing scanning lines 104WS_1 to 104WS_n for the n rows driven by a writing driving pulse WS by the writing scanning unit 104 and the driving scanning lines 105DS_1 to 105DS_n for the n rows driven by a scanning driving pulse DS by the driving scanning unit 105 as well as the threshold value & mobility correcting scanning lines 114AZ_1 to 114AZ_n for the n rows driven by a threshold value & mobility correcting pulse AZ1 by the first threshold value & mobility correcting scanning unit 114 and the threshold value & mobility correcting scanning lines 115AZ_1 to 115AZ_n for the n rows driven by a threshold value & mobility correcting pulse AZ2 by the second threshold value & mobility correcting scanning unit 115 are disposed for each pixel row of the pixel circuits P arranged in the form of a matrix.

The bootstrap circuit 130 includes an n-channel type detecting transistor 124 connected in parallel with the organic EL element 127 and supplied with the active-H threshold value & mobility correcting pulse AZ2, and is formed by the detecting transistor 124 and the storage capacitor 120 connected between the gate and the source of the drive transistor 121. The storage capacitor 120 also functions as a bootstrap capacitance.

The threshold value & mobility correcting circuit 140 includes an n-channel type detecting transistor 123 supplied with the active-H threshold value & mobility correcting pulse AZ1 between the gate terminal G of the drive transistor 121 and a second power supply potential Vc2, and is formed by the detecting transistor 123, the drive transistor 121, the light emission controlling transistor 122, and the storage capacitor 120 connected between the gate and the source of the drive transistor 121. The storage capacitor 120 also functions as a threshold voltage retaining capacitance retaining a detected threshold voltage Vth.

The drive transistor 121 has a drain terminal D connected to the drain terminal D of the light emission controlling transistor 122. The source terminal S of the light emission controlling transistor 122 is connected to a first power supply potential Vc1. The source terminal S of the drive transistor 121 is directly connected to the anode terminal A of the organic EL element 127. A point of connection between the source terminal S of the drive transistor 121 and the anode terminal A of the organic EL element 127 is set as a node ND121. The cathode terminal K of the organic EL element 127 is connected to grounding wiring Vcath (GND) common to all pixels which wiring supplies a reference potential, and is thus supplied with a cathode potential Vcath.

The sampling transistor 125 has a gate terminal G connected to the writing scanning line 104WS from the writing scanning unit 104, a drain terminal D connected to the video signal line 106HS, and a source terminal S connected to the gate terminal G of the drive transistor 121. A point of connection between the source terminal S of the sampling transistor 125 and the gate terminal G of the drive transistor 121 is set as a node ND122. The gate terminal G of the sampling transistor 125 is supplied with the active-H writing driving pulse WS from the writing scanning unit 104. The sampling transistor 125 can also be in a mode of connection in which the source terminal S and the drain terminal D are reversed. The storage capacitor 120 has one terminal connected to the source terminal S of the drive transistor 121, and another terminal connected to the gate terminal G of the same drive transistor 121.

The detecting transistor 123 is a switching transistor provided on the side of the gate terminal G (control input terminal) of the drive transistor 121. The detecting transistor 123 has a source terminal S connected to a ground potential Vofs as an example of an offset voltage, a drain terminal D connected to the gate terminal G of the drive transistor 121 (the node ND122), and a gate terminal G as a control input terminal connected to the threshold value & mobility correcting scanning line 114AZ. By turning on the detecting transistor 123, the potential of the gate terminal G of the drive transistor 121 is connected to the ground potential Vofs as a fixed potential via the detecting transistor 123.

The detecting transistor 124 is a switching transistor. The detecting transistor 124 has a drain terminal D connected to the node ND121 as the point of connection between the source terminal S of the drive transistor 121 and the anode terminal A of the organic EL element 127, a source terminal S connected to a ground potential Vs1 as an example of a reference potential, and a gate terminal G as a control input terminal connected to the threshold value & mobility correcting scanning line 115AZ.

By connecting the storage capacitor 120 between the gate and the source of the drive transistor 121 and turning on the detecting transistor 124, the potential of the source terminal S of the drive transistor 121 is connected to the ground potential Vs1 as a fixed potential via the detecting transistor 124.

The sampling transistor 125 operates when selected by the writing scanning line 104WS. The sampling transistor 125 samples a pixel signal Vsig (a signal potential Vin of the pixel signal Vsig) from the signal line 106HS, and retains a voltage having a magnitude corresponding to the signal potential Vin in the storage capacitor 120 via the node ND122. The potential retained by the storage capacitor 120 is ideally of the same magnitude as the signal potential Vin, but is actually lower than the signal potential Vin.

When the light emission controlling transistor 122 is on under the scanning driving pulse DS, the drive transistor 121 drives the organic EL element 127 by current according to the driving potential retained by the storage capacitor 120 (the gate-to-source voltage Vgs of the drive transistor 121 at this point in time). The light emission controlling transistor 122 conducts when selected by the driving scanning line 105DS so as to supply current from the first power supply potential Vc1 to the drive transistor 121.

Thus, by connecting the side of the drain terminal D as the power supply terminal of the drive transistor 121 to the first power supply potential Vc1 via the light emission controlling transistor 122, and controlling the on period of the light emission controlling transistor 122, it is possible to adjust the emission period and the non-emission period of the organic EL element 127, and thereby perform duty driving.

The detecting transistors 123 and 124 operate when respectively set in a selected state by supplying the active-H threshold value & mobility correcting pulses AZ1 and AZ2 from the threshold value & mobility correcting scanning units 114 and 115 to the threshold value & mobility correcting scanning lines 114AZ and 115AZ. The detecting transistor 123 and 124 perform a predetermined correcting operation (an operation of correcting variations in threshold voltage Vth and mobility μ in this case).

For example, in order to detect the threshold voltage Vth of the drive transistor 121 prior to the current driving of the organic EL element 127 and cancel the effect of the threshold voltage Vth in advance, the detected potential is retained in the storage capacitor 120.

As a condition for ensuring normal operation of the pixel circuit P having such a constitution, the ground potential Vs1 is set lower than a level obtained by subtracting the threshold voltage Vth of the drive transistor 121 from the ground potential Vofs. That is, “Vs1<Vofs−Vth”.

In addition, a level obtained by adding a threshold voltage VthEL of the organic EL element 127 to the potential Vcath of the cathode terminal K of the organic EL element 127 is set higher than a level obtained by subtracting the threshold voltage Vth of the drive transistor 121 from the ground potential Vs1. That is, “Vcath+VthEL>Vs1−Vth”. Preferably, the level of the ground potential Vofs is set in the vicinity of the lowest level of the pixel signal Vsig supplied from the signal line 106HS (in a range of the lowest level and lower).

In the pixel circuit P of the comparison example having such a constitution, the sampling transistor 125 conducts in response to the writing driving pulse WS supplied from the writing scanning line 104WS during a predetermined signal writing period (sampling period) so as to sample the video signal Vsig supplied from the signal line 106HS in the storage capacitor 120. The storage capacitor 120 applies an input voltage (gate-to-source voltage Vgs) between the gate and the source of the drive transistor 121 according to the sampled video signal Vsig.

The drive transistor 121 supplies an output current corresponding to the gate-to-source voltage Vgs as driving current Ids to the organic EL element 127 during a predetermined emission period. Incidentally, the driving current Ids has dependence on the carrier mobility μ of a channel region in the drive transistor 121 and the threshold voltage Vth of the drive transistor 121. The organic EL element 127 emits light at a luminance corresponding to the video signal Vsig (the signal potential Vin in particular) on the basis of the driving current Ids supplied from the drive transistor 121.

The pixel circuit P of the comparison example has a correcting section formed by switching transistors (the light emission controlling transistor 122 and the detecting transistors 123 and 124). In order to cancel the dependence of the driving current Ids on the carrier mobility p, the gate-to-source voltage Vgs retained by the storage capacitor 120 is corrected in advance at a start of an emission period.

Specifically, the correcting section (the switching transistors 122, 123, and 124) operates in a part (for example a second half side) of a signal writing period according to the writing driving pulse WS and the scanning driving pulse DS supplied from the writing scanning line 104WS and the driving scanning line 105DS so as to correct the gate-to-source voltage Vgs by extracting the driving current Ids from the drive transistor 121 in a state of the video signal Vsig being sampled and negatively feeding back the driving current Ids to the storage capacitor 120. Further, in order to cancel the dependence of the driving current Ids on the threshold voltage Vth, the correcting section (the switching transistors 122, 123, and 124) detects the threshold voltage Vth of the drive transistor 121 in advance prior to the signal writing period, and adds the detected threshold voltage Vth to the gate-to-source voltage Vgs.

In particular, in the pixel circuit P of the comparison example, the drive transistor 121 is an n-channel type transistor and has the drain thereof connected to the positive power side, while the source of the drive transistor 121 is connected to the organic EL element 127 side. In this case, the above-described correcting section extracts the driving current Ids from the drive transistor 121 and negatively feeds back the driving current Ids to the storage capacitor 120 side in a start part of an emission period overlapping a later part of the signal writing period.

At this time, the correcting section allows the driving current Ids extracted from the source terminal S side of the drive transistor 121 in the start part of the emission period to flow into the parasitic capacitance Ce1 of the organic EL element 127. Specifically, the organic EL element 127 is a diode type light emitting element having an anode terminal A and a cathode terminal K. The anode terminal A side is connected to the source terminal S of the drive transistor 121, while the cathode terminal K side is connected to a grounding side (the cathode potential Vcath in the present example).

With this constitution, the correcting section (the switching transistors 122, 123, and 124) sets a reverse-biased state between the anode and the cathode of the organic EL element 127 in advance, and thus makes the diode type organic EL element 127 function as a capacitive element when the driving current Ids extracted from the source terminal S side of the drive transistor 121 flows into the organic EL element 127.

Incidentally, the correcting section can adjust a duration t during which the driving current Ids is extracted from the drive transistor 121 within the signal writing period. The correcting section thereby optimizes an amount of negative feedback of the driving current Ids to the storage capacitor 120.

In this case, “optimizing the amount of negative feedback” means enabling mobility correction to be performed properly at any level in a range from a black level to a white level of video signal potential. The amount of negative feedback applied to the gate-to-source voltage Vgs is dependent on the extraction time of the driving current Ids. The longer the extraction time, the larger the amount of negative feedback.

For example, by providing a slope to a rising edge of the voltage of the signal line 106HS as a video line signal potential or a transition characteristic of the writing driving pulse WS of the writing scanning line 104WS, the mobility correcting period t is made to follow the video line signal potential automatically, and is thus optimized. That is, the mobility correcting period t can be determined by a phase difference between the writing scanning line 104WS and the signal line 106HS, and can also be determined by the potential of the signal line 106HS. A mobility correcting parameter ΔV is ΔV=Ids·Ce1/t.

As is clear from this equation, the higher the driving current Ids as the drain-to-source current of the drive transistor 121, the higher the mobility correcting parameter ΔV. Conversely, when the driving current Ids of the drive transistor 121 is low, the mobility correcting parameter ΔV is low. Thus, the mobility correcting parameter ΔV is determined according to the driving current Ids.

At this time, the mobility correcting period t does not necessarily need to be constant, and it may be rather desirable to adjust the mobility correcting period t according to the driving current Ids. For example, it is desirable to set the mobility correcting period t shorter when the driving current Ids is high, and conversely set the mobility correcting period t longer when the driving current Ids is decreased.

Accordingly, by providing a slope to a rising edge of the video signal line potential (the potential of the signal line 106HS) or the transition characteristic of the writing driving pulse WS of the writing scanning line 104WS, automatic adjustment is performed such that the correcting period t is shortened when the potential of the signal line 106HS is high (when the driving current Ids is high) and the correcting period t is lengthened when the potential of the signal line 106HS is low (when the driving current Ids is low). Thus, an appropriate correcting period can be set automatically in such a manner as to follow the video signal potential (the signal potential Vin of the video signal Vsig). An optimum mobility correction can therefore be made irrespective of the luminance or the pattern of an image.

### <Basic Operation>

First, an operation in a case where the light emission controlling transistor 122, the detecting transistor 123, and the detecting transistor 124 are not provided, and the storage capacitor 120 has one terminal connected to the node ND122 and the other terminal connected to the grounding wiring Vcath (GND) common to all pixels will be described as a comparison example for describing features of the pixel circuits P in FIG. 2 and according to the present embodiment to be described later. Such a pixel circuit P will hereinafter be referred to as the pixel circuit P of the first comparison example, and the pixel circuit P shown in FIG. 2 will be referred to as the pixel circuit P of the second comparison example to be differentiated from the pixel circuit P of the first comparison example. An organic EL display device 1 including the pixel circuit P of the second comparison example in a pixel array unit 102 will be referred to as the organic EL display device 1 of the second comparison example.

In the pixel circuit P of the first comparison example, the potential of the source terminal S (source potential Vs) of the drive transistor 121 is determined by the operating point of the drive transistor 121 and the organic EL element 127, and the voltage value differs depending on the gate potential Vg of the drive transistor 121.

Generally, as shown in FIG. 3, the drive transistor 121 is driven in a saturation region. Thus, letting Ids be the current flowing between the drain terminal and the source of the transistor operating in the saturation region, μ be mobility, W be a channel width (gate width), L be a channel length (gate length), Cox be a gate capacitance (gate oxide film capacitance per unit area), and Vth be the threshold voltage of the transistor, the drive transistor 121 is a constant-current source having a value as expressed by the following Equation (1). Incidentally, “̂” denotes a power. As is clear from Equation (1), in the saturation region, the drain current Ids of the transistor is controlled by the gate-to-source voltage Vgs, and the drive transistor 121 operates as a constant-current source.

$$Ids = \frac{1}{2} μ \frac{W}{L} {Cox ( Vgs - Vth )}^{⋀} 2 \qquad ( 1 )$$

### <Iel-Vel Characteristics and I-V Characteristics of Light Emitting Element>

In current-voltage (Iel-Vel) characteristics of a current-driven type light emitting element typified by an organic EL element which characteristics are shown in (1) of FIGS. 4A to 4C, a curve shown as a solid line indicates a characteristic at a time of an initial state, and a curve shown as a broken line indicates a characteristic after a secular change. In general, the I-V characteristics of current-driven type light emitting elements including an organic EL element are degraded with the passage of time as shown in the graph.

For example, when a light emission current Iel flows through the organic EL element 127 as an example of a light emitting element, the anode-to-cathode voltage Vel of the organic EL element 127 is determined uniquely. As shown in (1) of FIGS. 4A to 4C, during an emission period, the light emission current Iel determined by the drain-to-source current Ids (=driving current Ids) of the drive transistor 121 flows through the anode terminal A of the organic EL element 127, and the anode terminal A of the organic EL element 127 thereby rises by the anode-to-cathode voltage Vel.

In the pixel circuit P of the first comparison example, the anode-to-cathode voltage Vel for the same light emission current Iel is changed from Vel1 to Vel2 as a result of a secular change in the I-V characteristic of the organic EL element 127. Therefore the operating point of the drive transistor 121 is changed. Even when a same gate potential Vg is applied, the source potential Vs of the drive transistor 121 is changed. As a result, the gate-to-source voltage Vgs of the drive transistor 121 is changed.

In the simple circuit using an n-channel type as the drive transistor 121, the source terminal S of the drive transistor 121 is connected to the organic EL element 127 side, and therefore the simple circuit is affected by a secular change in the I-V characteristic of the organic EL element 127. An amount of current (light emission current Iel) flowing through the organic EL element 127 is thus changed. As a result, light emission luminance is changed.

Specifically, in the pixel circuit P of the first comparison example, the operating point is changed due to a secular change in the I-V characteristic of the organic EL element 127. Even when a same gate potential Vg is applied, the source potential Vs of the drive transistor 121 is changed. Thus, the gate-to-source voltage Vgs of the drive transistor 121 is changed. As is clear from the characteristic equation (1), a variation in the gate-to-source voltage Vgs varies the driving current Ids even when the gate potential Vg is constant, and at the same time changes the value of the current flowing through the organic EL element 127. Thus, in the pixel circuit P of the first comparison example, a change in the I-V characteristic of the organic EL element 127 leads to a secular change in the light emission luminance of the organic EL element 127.

In the simple circuit using an n-channel type as the drive transistor 121, the source terminal S of the drive transistor 121 is connected to the organic EL element 127 side, and therefore the gate-to-source voltage Vgs is changed with a secular change of the organic EL element 127. The amount of current flowing through the organic EL element 127 is thus changed. As a result, light emission luminance is changed.

A variation in the anode potential of the organic EL element 127 due to a secular change in the characteristic of the organic EL element 127 as an example of a light emitting element appears as a variation in the gate-to-source voltage Vgs of the drive transistor 121, and causes a variation in drain current (driving current Ids). The variation in the driving current from this cause appears as a variation in light emission luminance of each pixel circuit P, thus causing degradation in picture quality.

On the other hand, as will be described later in detail, by setting the sampling transistor 125 in a non-conducting state at a time when information corresponding to a signal potential Vin has been written to the storage capacitor 120 (and continuously holding the sampling transistor 125 in the non-conducting state during a subsequent emission period of the organic EL element 127), a bootstrap operation is performed in which a circuit configuration and driving timing are set to achieve a bootstrap function that makes the potential Vg of the gate terminal G of the drive transistor 121 interlocked with variation in the potential Vs of the source terminal S of the drive transistor 121.

Thereby, even when there is a variation in anode potential of the organic EL element 127 (that is, a variation in source potential) due to a secular change in the characteristic of the organic EL element 127, the gate potential Vg is varied so as to cancel the variation. Thus the uniformity of screen luminance can be secured. The bootstrap function can improve the capability of correcting a secular variation of a current-driven type light emitting element typified by an organic EL element.

This bootstrap function can be started at a time of a start of light emission at which time the writing driving pulse WS is changed to an inactive-L state and thus the sampling transistor 125 is turned off, and the bootstrap function also functions when the source potential Vs of the drive transistor 121 is thereafter changed with change in the anode-to-cathode voltage Vel in a process in which the light emission current Iel starts to flow through the organic EL element 127 and the anode-to-cathode voltage Vel rises with the start of the flow of the light emission current Iel until the anode-to-cathode voltage Vel stabilizes.

### <Vgs-Ids Characteristic of Drive Transistor>

In addition, due to variations in a process of manufacturing the drive transistor 121, there are characteristic variations in threshold voltage, mobility, and the like in each pixel circuit P. Even when the drive transistor 121 is driven in a saturation region and a same gate potential is supplied to the drive transistor 121, the characteristic variations change the drain current (driving current Ids) in each pixel circuit P, which change appears as non-uniformity of light emission luminance.

For example, (2) of FIGS. 4A to 4C are diagrams showing a voltage-current (Vgs-Ids) characteristic with attention directed to variations in threshold value of the drive transistor 121. Respective characteristic curves are cited with respect to two drive transistors 121 having different threshold voltages of Vth1 and Vth2.

As described above, the drain current Ids when the drive transistor 121 operates in a saturation region is expressed by the characteristic equation (1). As is clear from the characteristic equation (1), when the threshold voltage Vth varies, the drain current Ids varies even if the gate-to-source voltage Vgs is constant. That is, when no measure is taken against variations in the threshold voltage Vth, as shown in (2) of FIGS. 4A to 4C, a driving current corresponding to a gate voltage Vgs when the threshold voltage is Vth1 is Ids1, whereas a driving current Ids2 corresponding to the same gate voltage Vgs when the threshold voltage is Vth2 differs from Ids1.

Further, (3) of FIGS. 4A to 4C are diagrams showing a voltage-current (Vgs-Ids) characteristic with attention directed to variations in mobility of the drive transistor 121. Respective characteristic curves are cited with respect to two drive transistors 121 having different mobilities of μ1 and μ2.

As is clear from the characteristic equation (1), when the mobility μ varies, the drain current Ids varies even if the gate-to-source voltage Vgs is constant. That is, when no measure is taken against variations in the mobility p, as shown in (3) of FIGS. 4A to 4C, a driving current corresponding to a gate voltage Vgs when the mobility is μ1 is Ids1, whereas a driving current corresponding to the same gate voltage Vgs when the mobility is μ2 is Ids2, which differs from Ids1.

As shown in (2) of FIGS. 4A to 4C or (3) of FIGS. 4A to 4C, if a great difference occurs in Vin-Ids characteristic due to a difference in threshold voltage Vth or mobility p, the driving current Ids, that is, light emission luminance becomes different even when a same signal potential Vin is given. Therefore the uniformity of screen luminance may not be obtained.

### <Concept of Threshold Value Correction and Mobility Correction>

On the other hand, by setting driving timing for achieving a threshold value correcting function and a mobility correcting function (details will be described later), it is possible to suppress effects of these variations, and thus secure the uniformity of screen luminance.

In threshold value correcting operation and mobility correcting operation according to the second comparison example and the present embodiment, though details will be described later, the gate-to-source voltage Vgs at a time of light emission is expressed as “Vin+Vth−ΔV”. The drain-to-source current Ids is thereby prevented from being dependent on variations or changes in threshold voltage Vth and from being dependent on variations or changes in mobility μ. As a result, even when the threshold voltage Vth and the mobility μ are varied in a manufacturing process or with the passage of time, the driving current Ids does not vary, and thus the light emission luminance of the organic EL element 127 does not vary.

For example, FIG. 5 is a graph of assistance in explaining the operating point of the drive transistor 121 at a time of mobility correction. When threshold value correction and mobility correction such that the gate-to-source voltage Vgs at a time of light emission is expressed as “Vin+Vth−ΔV” is applied to variations of the mobilities μ1 and μ2 which variations occur in a manufacturing process or with the passage of time, first, from a viewpoint of mobility, a mobility correcting parameter ΔV1 is determined for the mobility μ1, and a mobility correcting parameter ΔV2 is determined for the mobility μ2.

Thereby, an appropriate mobility correcting parameter is determined for each mobility. Thus a driving current Idsa at the time of the mobility μ1 of the drive transistor 121 and a driving current Idsb at the time of the mobility μ2 are determined. While there is a great current variation before the mobility correction, the mobility correction reduces the current variation and thus suppresses a difference in mobility p. In an optimum state “Idsa=Idsb”, so that the difference in mobility p can be eliminated (canceled).

As is also shown in (3) of FIGS. 4A to 4C, if the mobility correction is not applied, and when there are different mobilities μ1 and μ2 for a gate-to-source voltage Vgs, there correspondingly occur significantly different driving currents Ids, that is, driving currents Ids1 and Ids2. In order to deal with this, appropriate mobility correcting parameters ΔV1 and ΔV2 are respectively applied to the mobilities μ1 and μ2, whereby the driving currents Ids1 and Ids2 become driving currents Idsa and Idsb. By optimizing each of the mobility correcting parameters ΔV1 and ΔV2, it is possible to make the driving currents Idsa and Idsb close to each other after the mobility correction, and set the driving currents Idsa and Idsb at a same level in an optimum state.

At the time of the mobility correction, as is clear from the graph of FIG. 5, a negative feedback is applied such that the mobility correcting parameter ΔV1 is increased for the high mobility μ1, while the mobility correcting parameter ΔV2 is decreased for the low mobility p. In this sense, the mobility correcting parameter ΔV is referred to also as an amount of negative feedback ΔV.

Each of diagrams of FIGS. 6A to 6D shows a relation between the signal potential Vin and the driving current Ids from a viewpoint of threshold value correction. For example, in each of the diagrams of FIGS. 6A to 6D showing the current-voltage characteristics of the drive transistor 121, an axis of abscissas indicates the signal potential Vin and an axis of ordinates indicates the driving current Ids, and respective characteristic curves are cited with respect to a pixel circuit Pa (the curve of a solid line) including a drive transistor 121 having a relatively low threshold voltage Vth and a relatively high mobility μ and a pixel circuit Pb (the curve of a dotted line) including a drive transistor 121 conversely having a relatively high threshold voltage Vth and a relatively low mobility μ.

(1) of FIGS. 6A to 6D corresponds to a case where neither of threshold value correction and mobility correction is made. At this time, the pixel circuit Pa and the pixel circuit Pb do not correct the threshold voltage Vth and the mobility μ at all, so that differences in the threshold voltage Vth and the mobility μ result in a great difference in the Vin-Ids characteristic. Hence, even when a same signal potential Vin is given, the driving current Ids, that is, light emission luminance differs, so that the uniformity of screen luminance may not be obtained.
(2) of FIGS. 6A to 6D corresponds to a case where threshold value correction is made but mobility correction is not made. At this time, the pixel circuit Pa and the pixel circuit Pb cancel out a difference in the threshold voltage Vth. However, a difference in the mobility μ appears as it is. Thus, the difference in the mobility μ appears noticeably in a region of high signal potential Vin (that is, a region of high luminance), resulting in different luminances for a same gradation. Specifically, for a same gradation (same signal potential Vin), the luminance (driving current Ids) of the pixel circuit Pa having a high mobility μ is high, and the luminance (driving current Ids) of the pixel circuit Pb having a low mobility μ is low.
(3) of FIGS. 6A to 6D corresponds to a case where threshold value correction and mobility correction are both made. Differences in the threshold voltage Vth and the mobility μ are completely corrected. As a result, the Vin-Ids characteristics of the pixel circuit Pa and the pixel circuit Pb coincide with each other. Thus, the luminance (Ids) is at a same level for all gradations (signal potentials Vin), so that the uniformity of screen luminance is improved significantly.
(4) of FIGS. 6A to 6D corresponds to a case where although threshold value correction and mobility correction are both made, the threshold voltage Vth is corrected insufficiently. For example, the voltage corresponding to the threshold voltage Vth of the drive transistor 121 may not be sufficiently retained in the storage capacitor 120 in one threshold value correcting operation. At this time, the difference in the threshold voltage Vth is not eliminated, so that the pixel circuit Pa and the pixel circuit Pb have different luminances (driving currents Ids) in a region of low gradations. Hence, when the threshold voltage Vth is corrected insufficiently, the non-uniformity of luminance occurs at low gradations, and thus image quality is impaired.

### <Operation of Pixel Circuit; Comparison Example>

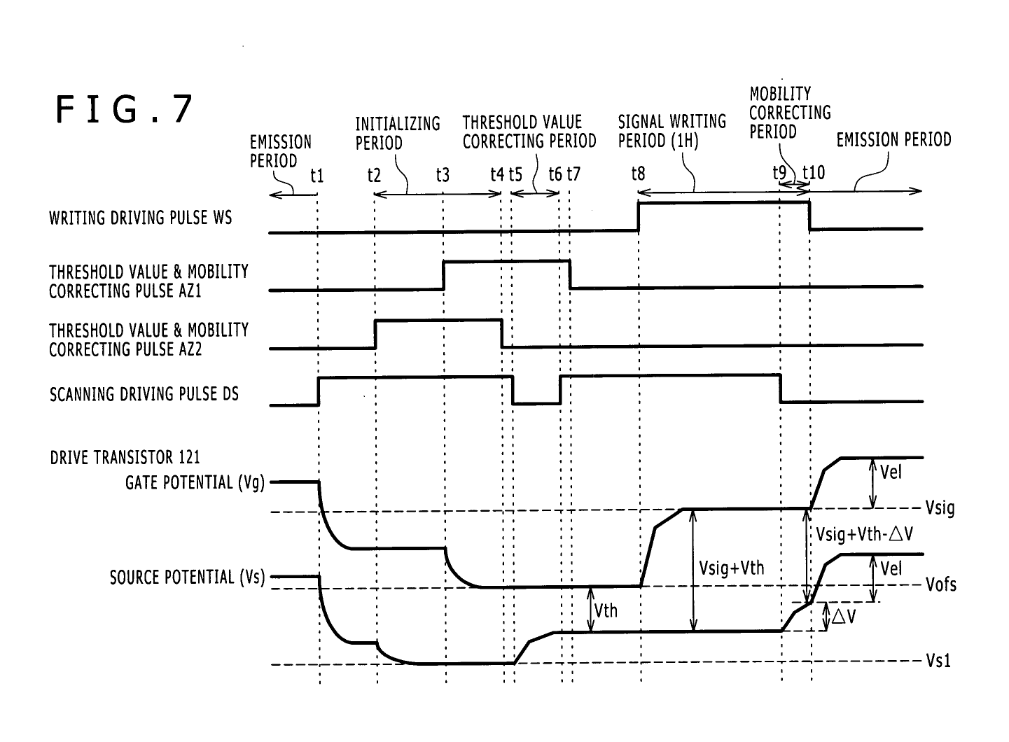

FIG. 7 is a timing chart of assistance in explaining the operation of the pixel circuit P of the second comparison example. Each driving pulse itself in driving timing of the present embodiment to be described later is basically the same as shown in the timing chart of FIG. 7. The timing chart of FIG. 7 effectively includes a timing chart showing the driving timing of the pixel circuit P according to the present embodiment.

FIG. 7 shows the waveforms of the writing driving pulse WS, the threshold value & mobility correcting pulses AZ1 and AZ2, and the scanning driving pulse DS along a time axis t. As is understood from the above description, since the switching transistors 123, 124, and 125 are of an n-channel type, the switching transistors 123, 124, and 125 are on when the respective pulses AZ1, AZ2, and WS are at a high (H) level, and are off when the respective pulses AZ1, AZ2, and WS are at a low (L) level. On the other hand, since the light emission controlling transistor 122 is of a p-channel type, the light emission controlling transistor 122 is off when the scanning driving pulse DS is at a high level, and is on when the scanning driving pulse DS is at a low level. Incidentally, this timing chart also shows changes in potential at the gate terminal G of the drive transistor 121 and changes in potential at the source terminal S of the drive transistor 121 together with the waveforms of the respective pulses WS, AZ1, AZ2, and DS.

In the pixel circuit P of the comparison example, in a normal light emission state, only the scanning driving pulse DS output from the driving scanning unit 105 is in an active-L state, and the other pulses, that is, the writing driving pulse WS and the threshold value & mobility correcting pulses AZ1 and AZ2 respectively output from the writing scanning unit 104 and the threshold value & mobility correcting scanning units 114 and 115 are in an inactive-L state. Therefore only the light emission controlling transistor 122 is in an on state.

Each row of the pixel array unit 102 is sequentially scanned once during one field. In a period before a field in question starts (before t1), all the pulses WS, AZ1, AZ2, and DS are at a low level. Thus, the n-channel type switching transistors 123, 124, and 125 are in an off state, whereas only the p-channel type light emission controlling transistor 122 is in an on state.

Hence, the drive transistor 121 is connected to the first power supply potential Vc1 via the light emission controlling transistor 122 in the on state, and thus supplies the driving current Ids to the organic EL element 127 according to a predetermined gate-to-source voltage Vgs. The organic EL element 127 is therefore emitting light before the timing t1. At this time, the gate-to-source voltage Vgs applied to the drive transistor 121 is expressed as a difference between the gate potential Vg and the source potential Vs.

At this time, the drive transistor 121 is set to operate in a saturation region. Thus, letting Ids be the current flowing between the drain terminal and the source of the transistor operating in the saturation region, μ be mobility, W be a channel width, L be a channel length, Cox be a gate capacitance, and Vth be the threshold voltage of the transistor, the drive transistor 121 is, in principle, a constant-current source having a value as expressed by Equation (1).

In the timing t1 in which a new field begins, the scanning driving pulse DS changes from a low level to a high level (t1). Thus, in the timing t1, all the switching transistors 122 to 125 are in the off state. The light emission controlling transistor 122 is thereby turned off to disconnect the drive transistor 121 from the first power supply potential Vc1. Therefore, the gate voltage Vg and the source voltage Vs are lowered, and the organic EL element 127 stops emitting light, whereby a non-emission period begins.

Next, the threshold value & mobility correcting pulses AZ1 and AZ2 are set to an active-H state in order, whereby the detecting transistors 123 and 124 are turned on. Incidentally, either of the detecting transistors 123 and 124 may be turned on first. Thus, current is prevented from flowing through the organic EL element 127, and the organic EL element 127 is set in a non-emission state. In the example shown in FIG. 7, the threshold value & mobility correcting pulse AZ2 is first set in the active-H state to turn on the detecting transistor 124 (t2), and then the threshold value & mobility correcting pulse AZ1 is set in the active-H state to turn on the detecting transistor 123 (t3).

At this time, the source terminal S of the drive transistor 121 is supplied with the ground potential Vs1 via the detecting transistor 124, whereby the source potential Vs of the drive transistor 121 is initialized (t2 to t3). In addition, the gate terminal G of the drive transistor 121 is supplied with the ground potential Vofs via the detecting transistor 123, whereby the gate potential Vg of the drive transistor 121 is initialized (t3 to t4).

A potential difference across the storage capacitor 120 connected between the gate and the source of the drive transistor 121 is thereby set equal to or higher than the threshold voltage Vth of the drive transistor 121. At this time, the gate-to-source voltage Vgs of the drive transistor 121 assumes a value of “Vofs−Vs1”. Since a setting is made such that “Vs1<Vofs−Vth”, the drive transistor 121 maintains an on state, and a corresponding current Ids1 flows.

In this case, to set the organic EL element 127 in the non-emission state needs a relation Vcath+VthEL>Vs1−Vth, that is, needs the setting of voltages of the ground potential Vofs and the ground potential Vs1 such that a voltage Vel (=Vs1−Vth) applied to the anode terminal A of the organic EL element 127 is lower than a sum of the threshold voltage VthEL of the organic EL element 127 and the cathode voltage Vcath. Then, the organic EL element 127 is set in a reverse-biased state, and no current flows through the organic EL element 127, so that the organic EL element 127 is in the non-emission state.

Hence, the drain current Ids1 of the drive transistor 121 flows from the first power supply potential Vc1 to the ground potential Vs1 via the detecting transistor 124 in the on state. In addition, by making a setting such that Vofs−Vs1=Vgs>Vth, a preparation for correction of a variation in the threshold voltage Vth, which correction is to be made in subsequent timing t5, is performed. In other words, a period from t2 to t5 corresponds to a period for resetting the drive transistor 121 (an initializing period) and a preparatory period for mobility correction.

As for the threshold voltage VthEL of the organic EL element 127, a setting is made such that VthEL>Vs1. Thereby a negative bias is applied to the organic EL element 127, and the organic EL element 127 is set in a so-called reverse-biased state. This reverse-biased state is necessary for normally performing operations of correcting a variation in the threshold voltage Vth and correcting a variation in the carrier mobility μ, which operations are to be performed later.

Next, the threshold value & mobility correcting pulse AZ2 is set in the inactive-L state (t4), and the scanning driving pulse DS is set in the active-L state at substantially the same time (with a little delay) (t5). Thereby, the detecting transistor 124 is turned off, whereas the light emission controlling transistor 122 is turned on. As a result, a driving current Ids flows into the storage capacitor 120. A threshold value correcting period for correcting (cancelling) the threshold voltage Vth of the drive transistor 121 begins.

The gate terminal G of the drive transistor 121 is maintained at the ground potential Vofs. The source potential Vs of the drive transistor 121 rises, and the driving current Ids flows until the drive transistor 121 cuts off. When the drive transistor 121 cuts off, the source potential Vs of the drive transistor 121 becomes “Vofs−Vth”.

That is, because an equivalent circuit of the organic EL element 127 is represented by a parallel circuit of a diode and a parasitic capacitance Ce1, as long as “Vel≦Vcath+VthEL”, that is, as long as a leakage current of the organic EL element 127 is considerably lower than the current flowing through the drive transistor 121, the current of the drive transistor 121 is used to charge the storage capacitor 120 and the parasitic capacitance Ce1.

Consequently, when the current path of the drain current flowing through the drive transistor 121 is blocked, the voltage Vel at the anode terminal A of the organic EL element 127, that is, the potential of the node ND121 rises with time. Then, when a potential difference between the potential of the node ND121 (source voltage Vs) and the voltage of the node ND122 (gate voltage Vg) becomes exactly the threshold voltage Vth, the drive transistor 121 changes from the on state to the off state, and thus the drain current stops flowing. Thereby the threshold value correcting period is ended. That is, after the passage of a certain time, the gate-to-source voltage Vgs of the drive transistor 121 assumes the value of the threshold voltage Vth.

At this time, “Vel=Vofs−Vth≦Vcath+VthEL”. That is, the potential difference=Threshold Voltage Vth appearing between the node ND121 and the node ND122 is retained by the storage capacitor 120. Thus, the detecting transistors 123 and 124 operate when selected in appropriate timing by the threshold value & mobility correcting scanning lines 114AZ and 115AZ, respectively, to detect the threshold voltage Vth of the drive transistor 121 and retain the threshold voltage Vth of the drive transistor 121 in the storage capacitor 120.

The scanning driving pulse DS is set in an inactive-H state (t6) and the threshold value & mobility correcting pulse AZ1 is set in the inactive-L state (t7) in this order, whereby the light emission controlling transistor 122 and the detecting transistor 123 are turned off in this order to end the threshold value cancelling operation. By turning off the light emission controlling transistor 122 before the detecting transistor 123, it is possible to suppress a variation in voltage Vg at the gate terminal G of the drive transistor 121.

Incidentally, the detected threshold voltage Vth of the drive transistor 121 continues being retained by the storage capacitor 120 as a correcting potential after the passage of the threshold value cancelling period (Vth correcting period).

Thus, a period from timing t5 to timing t6 is a period for detecting the threshold voltage Vth of the drive transistor 121. This detecting period from t5 to t6 is herein referred to as a threshold value correcting period.

Next, the writing driving pulse WS is set in an active-H state to turn on the sampling transistor 125 so that a pixel signal Vsig is written to the storage capacitor 120 (the writing of the pixel signal Vsig is referred to also as sampling) (t8 to t10). The sampling of such a video signal Vsig is performed until timing t10, in which timing the writing driving pulse WS returns to the inactive-L state. That is, a period from timing t8 to timing t10 is referred to as a signal writing period (hereinafter referred to also as a sampling period). Generally, the sampling period is set in one horizontal period (1H).

In this sampling period (t8 to t10), the signal potential Vin of the pixel signal Vsig is supplied to the gate terminal G of the drive transistor 121, and thereby the gate voltage Vg is set to a driving potential corresponding to the signal potential Vin. A rate of magnitude of the information corresponding to the signal potential Vin and written to the storage capacitor 120 will be referred to as a writing gain Ginput. At this time, the pixel signal Vsig is retained in a form of being added to the threshold voltage Vth of the drive transistor 121. As a result, variations in the threshold voltage Vth of the drive transistor 121 are typically cancelled, which means that threshold value correction is made.

The gate-to-source voltage Vgs of the drive transistor 121, that is, the driving potential written to the storage capacitor 120 is determined as in Equation (2) by the storage capacitor 120 (capacitance value Cs), the parasitic capacitance Ce1 of the organic EL element 127 (capacitance value Ce1), and a parasitic capacitance between the gate and the source (capacitance value Cgs).

$$Vgs = \frac{Cel}{Cel + Cs + Cgs} ( Vsig - Vofs ) + Vth \qquad ( 2 )$$

In general, however, the parasitic capacitance Ce1 is much higher than the capacitance value Cs of the storage capacitor 120 and the capacitance value Cgs between the gate and the source, that is, the storage capacitor 120 is sufficiently lower than the parasitic capacitance (equivalent capacitance) Ce1 of the organic EL element 127. As a result, most of the video signal Vsig is written to the storage capacitor 120. To be exact, a difference of the video signal Vsig from the ground potential Vofs, that is, “Vsig−Vofs” is written to the storage capacitor 120.

Thus, the gate-to-source voltage Vgs of the drive transistor 121 is equal to a level “Vsig−Vofs+Vth” obtained by adding the threshold voltage Vth previously detected and retained to “Vsig−Vofs” sampled this time. At this time, when the ground potential Vofs is set in the vicinity of the black level of the pixel signal Vsig, the ground potential Vofs can be set at Vofs=0 V. Accordingly, the gate-to-source voltage Vgs (=driving potential) becomes substantially equal to “Vsig+Vth”.

The scanning driving pulse DS is set in the active-L state to turn on the light emission controlling transistor 122 (t9) before timing t10 in which the signal writing period is ended. Thereby, the drain terminal D of the drive transistor 121 is connected to the first power supply potential Vc1 via the light emission controlling transistor 122, so that the pixel circuit P proceeds from the non-emission period to an emission period.

The mobility of the drive transistor 121 is corrected during a period from t9 to t10 during which the sampling transistor 125 is thus still in the on state and the light emission controlling transistor 122 is set in the on state. The correction of the mobility of the drive transistor 121 in each pixel is optimized by adjusting a period (referred to as a mobility correcting period) during which the active periods of the writing driving pulse WS and the scanning driving pulse DS overlap each other. That is, the mobility correction is performed properly during the period from t9 to t10 during which a later part of the signal writing period and a start part of the emission period overlap each other.

Incidentally, in actuality, the organic EL element 127 is in the reverse-biased state and thus does not emit light at the start of the emission period at which the mobility correction is performed. During the mobility correcting period from t9 to t10, the driving current Ids flows to the drive transistor 121 with the gate terminal G of the drive transistor 121 fixed to a potential corresponding to the video signal Vsig (the signal potential Vin to be more exact).

In this case, by making a setting such that “Vofs−Vth<VthEL”, the organic EL element 127 is set in the reverse-biased state, and thus exhibits a simple capacitance characteristic rather than a diode characteristic. Hence, the driving current Ids flowing to the drive transistor 121 is written to a capacitance “C=Cs+Ce1” obtained by combining both of the capacitance value Cs of the storage capacitor 120 and the capacitance value Ce1 of the parasitic capacitance (equivalent capacitance) Ce1 of the organic EL element 127. Thereby the source potential Vs of the drive transistor 121 rises.

In the timing chart of FIG. 7, this rise is represented by ΔV. The rise, that is, an amount of negative feedback ΔV as a mobility correction parameter is eventually subtracted from the gate-to-source voltage Vgs retained by the storage capacitor 120, so that negative feedback is applied. The mobility μ can be corrected by thus negatively feeding back the driving current Ids of the drive transistor 121 to the gate-to-source voltage Vgs of the same drive transistor 121. Incidentally, the amount of negative feedback ΔV can be optimized by adjusting the duration t of the mobility correcting period from t9 to t10.

In the present example, the higher the level of the video signal Vsig, the higher the driving current Ids, and the higher the absolute value of ΔV. Hence, a mobility correction according to the level of light emission luminance can be made. In addition, when consideration is given to a drive transistor 121 of high mobility and a drive transistor 121 of low mobility, supposing that the video signal Vsig is fixed, the higher the mobility μ of the drive transistor 121, the higher the absolute value of ΔV.

In other words, the source potential of the drive transistor 121 of high mobility rises greatly during the mobility correcting period as compared with the drive transistor 121 of low mobility. In addition, the negative feedback is applied such that the larger the rise in source potential, the smaller the potential difference between the gate and the source, and thus the more difficult it becomes for the current to flow. Because the higher the mobility μ, the larger the amount of negative feedback ΔV, a variation in mobility μ in each pixel can be eliminated. Even the drive transistors 121 different in mobility can send the same driving current Ids through the organic EL element 127. The amount of negative feedback ΔV can be optimized by adjusting the mobility correcting period.

Next, the writing scanning unit 104 changes the writing driving pulse WS to the inactive-L state (t10). Thereby, the sampling transistor 125 is set in a non-conducting (off) state, and an emission period begins. Thereafter, a transition is made to a next frame (or a next field), where the threshold value correction preparatory operation, the threshold value correcting operation, the mobility correcting operation, and the light emitting operation are repeated.

As a result, the gate terminal G of the drive transistor 121 is disconnected from the video signal line 106HS. Because the application of the signal potential Vin to the gate terminal G of the drive transistor 121 is cancelled, the gate potential Vg of the drive transistor 121 becomes able to rise.

At this time, the driving current Ids flowing through the drive transistor 121 flows to the organic EL element 127, and the anode potential of the organic EL element 127 rises according to the driving current Ids. Suppose that this rise is Vel. At this time, the gate-to-source voltage Vgs of the drive transistor 121 is constant due to an effect of the storage capacitor 120, and thus the drive transistor 121 sends a constant current (driving current Ids) to the organic EL element 127. As a result, a voltage drop occurs, and the potential Vel at the anode terminal A of the organic EL element 127 (=the potential of the node ND121) rises to a voltage at which a current, or the driving current Ids, can flow through the organic EL element 127. Meanwhile, the gate-to-source voltage Vgs retained by the storage capacitor 120 maintains a value of “Vsig+Vth−ΔV”.

Eventually, as the source potential Vs rises, the reverse-biased state of the organic EL element 127 is cancelled, and thus the driving current Ids flows into the organic EL element 127, whereby the organic EL element 127 actually starts emitting light. The rise (Vel) in the anode potential of the organic EL element 127 at this time is none other than the rise in the source potential Vs of the drive transistor 121. The source potential Vs of the drive transistor 121 is “−Vth+ΔV+Vel”.

A relation between the driving current Ids and the gate voltage Vgs at the time of light emission can be expressed as in Equation (3) by substituting “Vsig+Vth−ΔV” for Vgs in Equation (1) expressing the above-described transistor characteristic.

Ids=kμ(Vga−Vth)̂2=kμ(Vsig−ΔV)̂2 (3)

In Equation (3), k=(1/2)(W/L)Cox. Equation (3) shows that the term of the threshold voltage Vth is cancelled, and that the driving current Ids supplied to the organic EL element 127 is not dependent on the threshold voltage Vth of the drive transistor 121. The driving current Ids is basically determined by the signal voltage Vsig of the video signal. In other words, the organic EL element 127 emits light at a luminance corresponding to the video signal Vsig.

At this time, the signal potential Vin is corrected by the amount of feedback ΔV. The amount of correction ΔV acts exactly to cancel the effect of the mobility p positioned in a coefficient part of Equation (3). Thus, the driving current Ids is in effect dependent on only the signal potential Vin. Because the driving current Ids is not dependent on the threshold voltage Vth, even when the threshold voltage Vth is varied by a manufacturing process, the driving current Ids between the drain and the source is not varied, and thus the light emission luminance of the organic EL element 127 is not varied either.

The storage capacitor 120 is connected between the gate terminal G and the source terminal S of the drive transistor 121. Due to an effect of the storage capacitor 120, the bootstrap operation is performed at a start of the emission period, in which operation the gate potential Vg and the source potential Vs of the drive transistor 121 rise while the gate-to-source voltage “Vgs=Vin−ΔV+Vth” of the drive transistor 121 is held constant. The source potential Vs of the drive transistor 121 becomes “−Vth+ΔV+Vel”, and thereby the gate potential Vg becomes “Vin+Vel”.

The I-V characteristic of the organic EL element 127 is changed as the emission period becomes longer. Therefore the potential of the node ND121 is also changed. However, due to an effect of the storage capacitor 120, the potential of the node ND122 rises in such a manner as to be interlocked with a rise in the potential of the node ND121. The gate-to-source voltage Vgs of the drive transistor 121 is thus maintained at about “Vsig+Vth−ΔV” at all times irrespective of rises in the potential of the node ND121. Therefore the current flowing through the organic EL element 127 is unchanged. Hence, even when the I-V characteristic of the organic EL element 127 is degraded, the constant current Ids continues flowing at all times. Thus, the organic EL element 127 continues emitting light at a luminance corresponding to the pixel signal Vsig, and the luminance does not vary.

Thereafter, in timing t1 of a next field, the scanning driving pulse DS is set in the inactive-H state to turn off the light emission controlling transistor 122. Thereby, the light emission is ended, and the field in question is ended. Thereafter, as described above, a transition is made to operation for the next field, where the threshold voltage correcting operation, the mobility correcting operation, and the light emitting operation are repeated.

Thus, in the pixel circuit P of the second comparison example, the bootstrap circuit 130 functions as a driving signal uniformizing circuit for correcting changes in the current-voltage characteristic of the organic EL element 127 as an example of an electrooptic element and thereby maintaining the driving current at a constant level.

In addition, the pixel circuit P of the second comparison example has the threshold value & mobility correcting circuit 140. The detecting transistors 123 and 124 in the threshold value correcting period can act to cancel the threshold voltage Vth of the drive transistor 121 and thus send the constant current Ids unaffected by variations in the threshold voltage Vth. It is therefore possible to make a display at a stable gradation corresponding to an input pixel signal, and thus obtain an image of high image quality.

In addition, as a result of the action during the mobility correcting period of the light emission controlling transistor 122 interlocked with the operation of writing the video signal Vsig by the sampling transistor 125, the gate-to-source voltage Vgs reflecting the carrier mobility μ of the drive transistor 121 can be set, and the constant current Ids unaffected by variations in the carrier mobility μ can be made to flow. It is therefore possible to make a display at a stable gradation corresponding to an input pixel signal, and thus obtain an image of high image quality.

That is, in order to prevent the effects of characteristic variations of the drive transistor 121 (variations in the threshold voltage Vth and the carrier mobility μ in the present example) on the driving current Ids, the threshold value & mobility correcting circuit 140 functions as driving signal uniformizing circuit for correcting the effects of the threshold voltage Vth and the carrier mobility μ and thereby holding the driving current constant.

The circuit configuration of the bootstrap circuit 130 and the threshold value & mobility correcting circuit 140 shown in the second comparison example is a mere example of the driving signal uniformizing circuit for holding constant the driving signal for driving the organic EL element 127 using an n-channel type as drive transistor 121. Various other circuits that are publicly known can be applied as driving signal uniformizing circuit for preventing the effects of a secular degradation of the organic EL element 127 and characteristic variations of the n-channel type drive transistor 121 (for example variations and changes in threshold voltage, mobility and the like) on the driving current Ids.

### <Adverse Effect of Mobility Correction>

Consideration will be given in the following to the effect of mobility correction and the adverse effect of the mobility correction with reference to FIG. 5 and FIG. 7. As described with reference to FIG. 5, a difference in mobility μ can be suppressed by applying threshold value correction and mobility correction such that the gate-to-source voltage Vgs at a time of light emission is expressed as “Vin+Vth−ΔV” to variations of mobilities p1 and μ2 which variations occur in a manufacturing process or with the passage of time. The difference in mobility μ can be eliminated by adjusting the mobility correcting period and thereby optimizing each of the mobility correcting parameters ΔV1 and ΔV2 (ΔV=Ids·t/Ce1).

However, in the driving timing shown in FIG. 7, the period during which the active periods of the writing driving pulse WS and the scanning driving pulse DS (that is, the respective on periods of the light emission controlling transistor 122 and the sampling transistor 125) overlap each other after the writing driving pulse WS is set in the active-H state and thereby the sampling transistor 125 is turned on to write information (driving potential) corresponding to the signal potential Vin to the storage capacitor 120 is set as the mobility correcting period (from t9 to t10). During the mobility correcting period, the video signal Vsig (signal potential Vin) continues being supplied to the drive transistor 121. While the gate potential Vg remains fixed, the source potential Vs of the drive transistor 121 rises by a mobility correcting parameter ΔV as an amount of mobility correction.

The rise ΔV in the source potential Vs during the mobility correcting period affects the gate-to-source voltage Vgs (=Vsig+Vth) of the drive transistor 121 at the point in time. The gate-to-source voltage Vgs is reduced by the rise ΔV in the source potential Vs. The gate-to-source voltage Vgs (that is, the driving potential) contributing to the driving current Ids during the emission period is therefore decreased. Thus light emission luminance is lowered as compared with a case where mobility correction is not made.

As a method of preventing a decrease in light emission luminance which decrease is caused by the mobility correction, for example, a voltage obtained by adding ΔV to the video signal Vsig (signal potential Vin to be more exact) necessary for the emission of light at a desired luminance may be written during the sampling period (t8 to t9). That is, the video signal Vsig of larger magnitude may be supplied to the pixel circuit P and thereby a higher driving potential may be written to the storage capacitor 120 so as to compensate for the decrease in the gate-to-source voltage Vgs due to the mobility correction. However, this method results in a substantial increase in the amplitude of the signal potential Vin as compared with the case where the mobility correction is not made. It is thus necessary to increase the power supply voltage and the magnitude of the writing driving pulse WS, which leads to an increase in voltage consumption.

Accordingly, in preventing the decrease in the gate-to-source voltage Vgs due to the mobility correction, the present embodiment has a mechanism that can prevent the decrease in the gate-to-source voltage Vgs due to the mobility correction without adding the amount of the mobility correcting parameter ΔV to the video signal Vsig (signal potential Vin to be more exact). Concrete description will be made in the following.

### <Pixel Circuit; Present Embodiment>

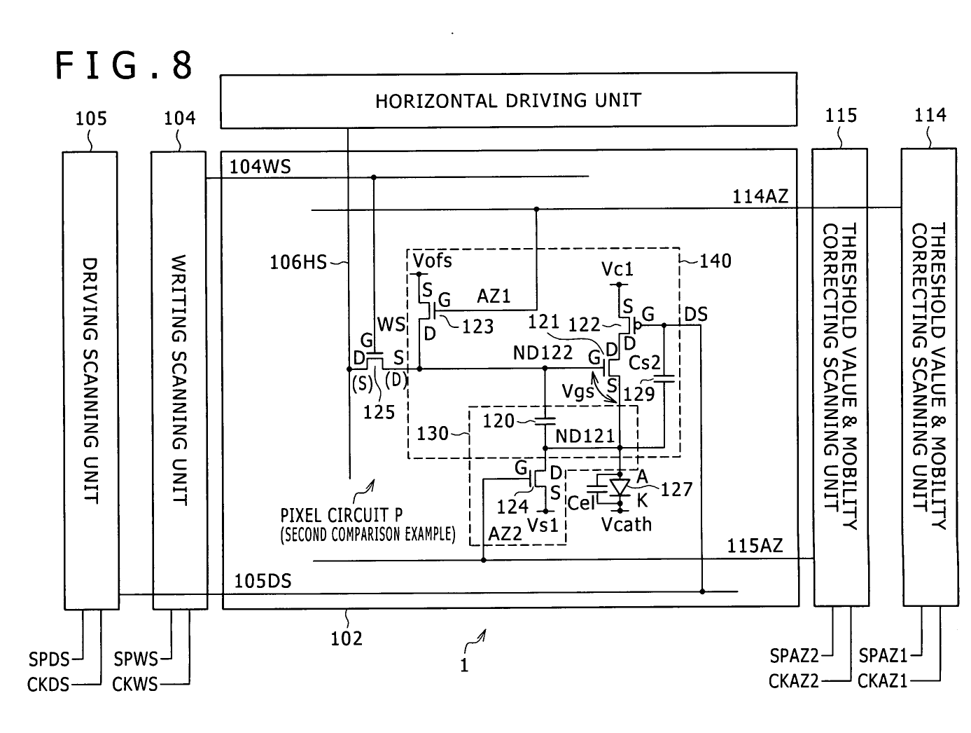

FIG. 8 is a diagram showing a pixel circuit P according to the present embodiment that can prevent the decrease in the gate-to-source voltage Vgs due to the mobility correction without adding the amount of the mobility correcting parameter ΔV to the video signal Vsig and an embodiment of an organic EL display device including the pixel circuit P. The organic EL display device including the pixel circuit P according to the present embodiment in a pixel array unit 102 will be referred to as an organic EL display device 1 according to the present embodiment.

The organic EL display device 1 according to the present embodiment has characteristics in that the organic EL display device 1 has a pixel array unit 102 in which a plurality of pixel circuits P each having functional elements similar to those of the pixel circuit P of the second comparison example shown in FIG. 2 are arranged in the form of a matrix, in that the organic EL display device 1 incorporates a circuit (bootstrap circuit) for preventing a variation in driving current due to a secular degradation of an organic EL element 127, and in that the organic EL display device 1 employs a driving system for preventing a variation in driving current due to a characteristic variation of a drive transistor 121 (a variation in threshold voltage or a variation in mobility). Thus, basically, the same driving timing as the driving timing of the second comparison example as shown in FIG. 7 is applied.

In addition, the organic EL display device 1 according to the present embodiment has a characteristic in that in each pixel circuit P, a capacitive element 129 having a capacitance value Cs2 is added so as to be connected to the gate terminal G of a light emission controlling transistor 122 and a node ND121 (a point of connection between the source terminal S of the drive transistor 121, one terminal of a storage capacitor 120, and the anode terminal A of the organic EL element 127), and transition information of a scanning driving pulse DS supplied to the gate terminal G of the light emission controlling transistor 122 (especially information in a direction of widening a gate-to-source voltage with respect to a source potential at a start of mobility correction) is supplied to the node ND121 via the capacitive element 129, whereby the gate-to-source voltage Vgs during an emission period is widened.

### <Operation of Pixel Circuit; Present Embodiment>

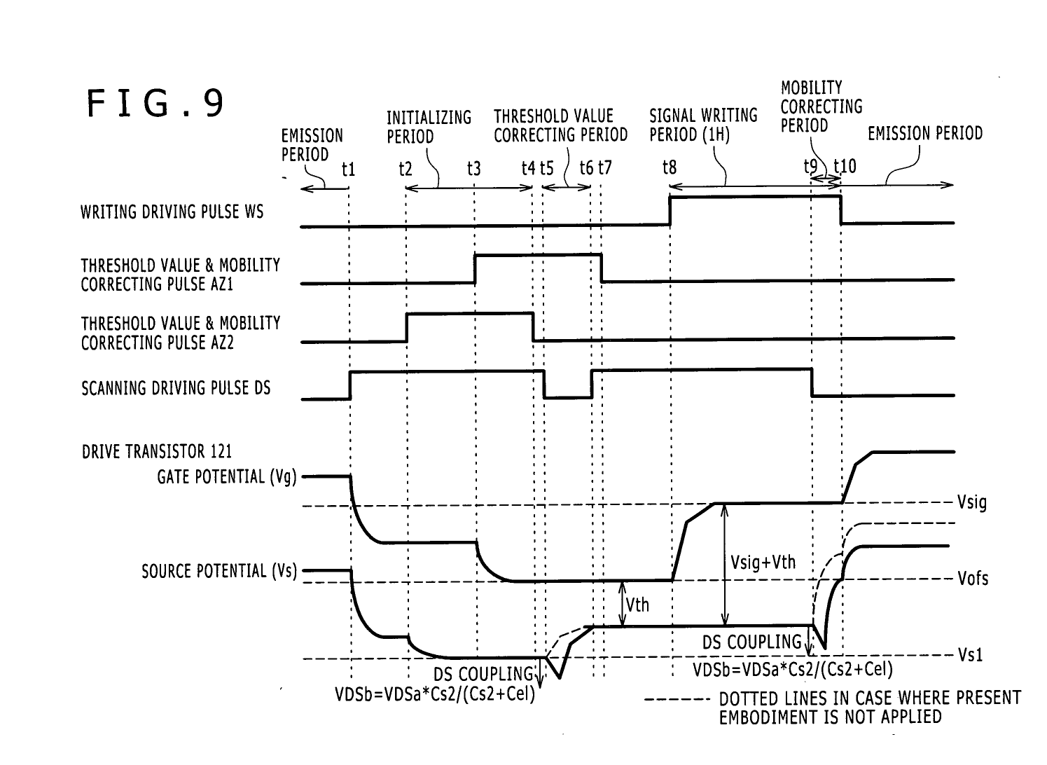

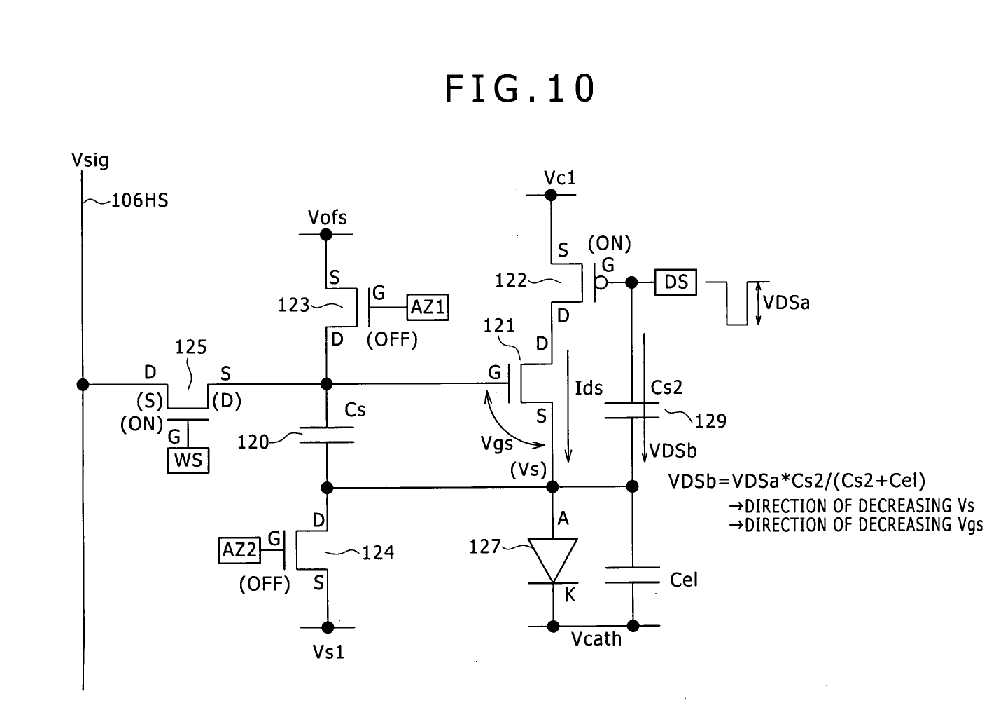

FIG. 9 is a timing chart of assistance in explaining the operation of the pixel circuit according to the present embodiment. FIG. 10 is a diagram of assistance in explaining an operation of correcting a decrease in gate-to-source voltage Vgs due to mobility correction.

As is presumed from comparison with the timing chart of FIG. 7, in which the pixel circuit P of the second comparison example is driven, driving pulses themselves for respective switch transistors 122, 123, 124, and 125 are not different.

However, the pixel circuit P according to the present embodiment has the capacitive element 129 between the gate terminal G of the p-channel type light emission controlling transistor 122 and the node ND121, that is, the source terminal of the drive transistor 121. The transition information of the scanning driving pulse DS is added to the potential of the node ND121 (the source potential Vs). Further, while the sampling transistor 125 is off, the gate potential Vg also rises slightly due to an effect of the storage capacitor 120.

Thus, for example, at the time of an operation of turning off the light emission controlling transistor 122 (timing t1 and timing t6) at which time the scanning driving pulse DS changes from an active-L state to an inactive-H state, a variation in voltage at the gate terminal G of the light emission controlling transistor 122 is input as a positive coupling VDS (VDS is the amplitude of the scanning driving pulse DS) to the source of the drive transistor 121 via the capacitive element 129. Therefore the source potential Vs and the gate potential Vg of the drive transistor 121 rise slightly.

On the other hand, at the time of an operation of turning on the light emission controlling transistor 122 (timing t5 and timing t9) at which time the scanning driving pulse DS changes from the inactive-H state to the active-L state, a variation in voltage at the gate terminal G of the light emission controlling transistor 122 is input as a negative coupling VDS to the source of the drive transistor 121 via the capacitive element 129. Therefore the source potential Vs and the gate potential Vg of the drive transistor 121 drop slightly.

Letting VDSa (V: volts) be the amplitude VDS of the scanning driving pulse DS, a voltage VDSb (V: volts) coupled to the source terminal S side of the drive transistor 121 via the capacitive element 129 is expressed by Equation (4).

VDSb=VDSa*Cs2/(Cs2+Ce1) (4)

For example, because the coupling is in timing (t9) in which the light emission controlling transistor 122 is turned on, the gate-to-source voltage Vgs of the drive transistor 121 becomes “Vth+VDSb”. The sampling transistor 125 is thereafter turned on to thereby write a signal potential (a value corresponding to the video signal Vsig) necessary for a desired light emission to the storage capacitor 120, so that “Vgs=Vth+VDSb+Vsig”. The on period of the light emission controlling transistor 122 overlaps the on period of the sampling transistor 125, whereby a mobility correcting period begins. In this case, supposing that an amount of coupling of VDSb is equal to a voltage consumed by the mobility correction, the gate-to-source voltage Vgs after the mobility correction is “Vth+Vsig”. A transition is made to an emission period after the turning off of the sampling transistor 125.

Thus, in the mechanism of the present embodiment, the capacitive element 129 is added between the gate terminal G of the p-channel type light emission controlling transistor 122 supplied with the active-L scanning driving pulse DS and the source terminal S of the drive transistor 121 (the node ND121), and transition information of the scanning driving pulse DS (especially information in a direction of widening the gate-to-source voltage with respect to the source potential at the start of the mobility correction) is supplied to the node ND121 via the capacitive element 129.

The gate-to-source voltage Vgs decreased by ΔV due to the mobility correction is widened by the amount of the coupling voltage VDSb due to the scanning driving pulse DS at a start of mobility correcting operation (before the mobility correction), that is, the voltage ΔV consumed at the time of the mobility correction is compensated by adding the amount of the voltage VDSb by the coupling based on the scanning driving pulse DS supplied to the light emission controlling transistor 122. The gate-to-source voltage Vgs during the emission period can therefore be widened. It is thereby possible to prevent a decrease in light emission luminance which decrease is caused by the mobility correction, decrease the amplitude of the video signal Vsig (signal potential Vin), and contribute to a reduction in power consumption because it suffices only to write a normal video signal Vsig to the storage capacitor 120.

In preventing the decrease in light emission luminance which decrease is caused by the mobility correction, the decrease in light emission luminance which decrease is caused by the mobility correction can be prevented without adding the amount of the mobility correcting parameter ΔV to the video signal Vsig (the signal potential Vin to be more exact). It is therefore possible to contribute to a reduction in power consumption of the panel.

Besides, as an additional effect, an increase in writing gain Ginput when the information of the video signal Vsig (the signal potential Vin to be more exact) is written to the storage capacitor 120 can be expected. For example, ignoring a parasitic capacitance formed at the gate terminal G of the drive transistor 121, using the capacitance value Cs of the storage capacitor 120 and the parasitic capacitance Ce1 of the organic EL element 127, the writing gain Ginput0 in the pixel circuit P of the second comparison example shown in FIG. 2 can be expressed as in Equation (5-1), while the writing gain Ginput1 in the pixel circuit P of the present embodiment shown in FIG. 8 can be expressed as in Equation (5-2).

Ginput0=1=Cs/(Cs+Ce1) (5-1)

Ginptut1=1=Cs/(Cs+Cs2+Ce1) (5-2)

As is understood from comparison between Equation (5-1) and Equation (5-2), an increase in writing gain Ginput is expected in the pixel circuit P of the present embodiment. Thus, considering a case of making light emission luminance the same as existing light emission luminance, a lower signal potential Vin suffices, so that the amplitude of the video signal Vsig can be further decreased and thus a reduction in power consumption can be further promoted.

Thus, by compensating for the voltage of the amount (mobility correcting parameter ΔV) consumed at the time of the mobility correction by the coupling effect of falling edge information of the scanning driving pulse DS indicating a start of the mobility correcting period which information jumps in via the capacitive element 129 disposed between the gate terminal of the light emission controlling transistor 122 and the source terminal of the drive transistor 121, it is possible to reduce signal amplitude greatly and therefore contribute greatly to a reduction in power consumption.

### <Example of Modification>

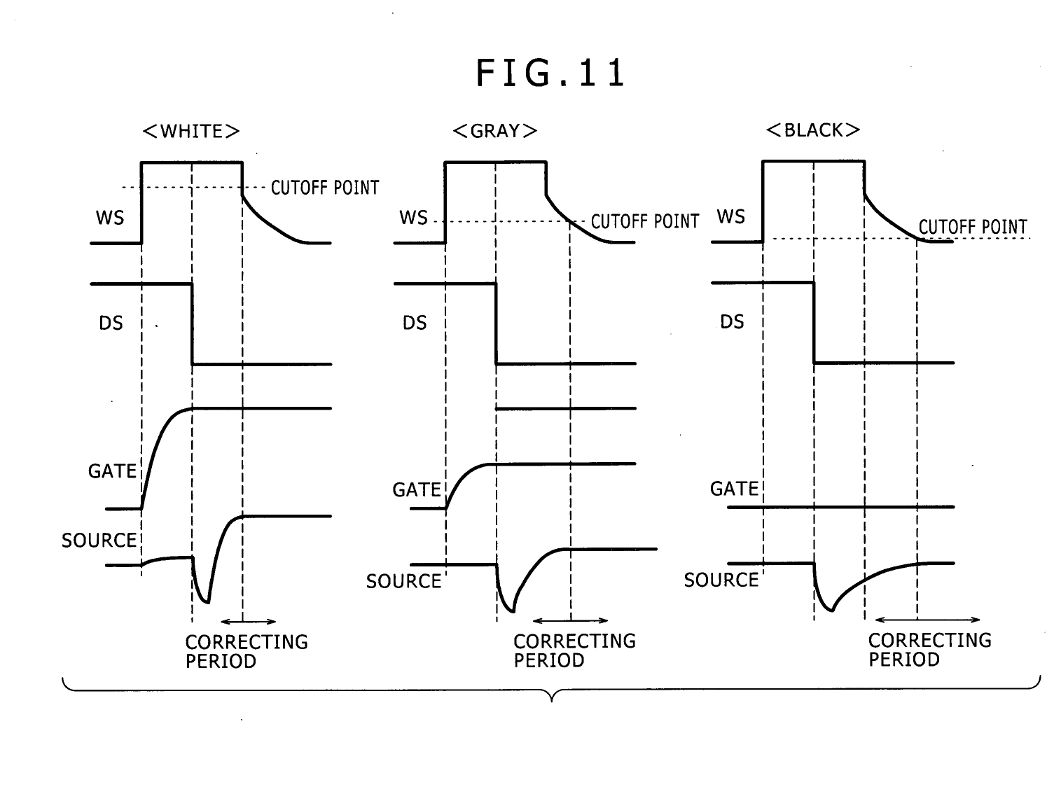

FIG. 11 is a diagram of assistance in explaining the operation of a modification example for correcting a decrease in gate-to-source voltage Vgs due to mobility correction. FIG. 11 shows the driving pulses WS and DS and respective voltages at the gate and the source of the drive transistor 121 at the time of DS coupling in display of white, gray, and black in a combination of a mechanism of changing a cutoff point for each gradation by blunting a falling edge of the writing driving pulse WS and the DS coupling.

In the above-described correcting mechanism, the amount of a Vgs complement is actually constant irrespective of gradations. Thus, for example, black floating may occur. On the other hand, for an optimum mobility correcting time for each gradation, there is a mechanism of changing a cutoff point for each gradation by blunting a falling edge of the writing driving pulse WS. The use of this mechanism makes it possible to widen the gate-to-source voltage Vgs by DS coupling and thus lower signal voltage in the region of a white signal and increase an amount of mobility correction and thus achieve a desired luminance for a gray-to-black signal by blunting a falling edge of the writing driving pulse WS.

That is, the DS coupling adds a voltage for “signal writing+α” to the gate-to-source voltage Vgs. This α is constant irrespective of signal voltage. A problem in this case, however, is a luminance higher than a desired luminance at a low gradation. In a case of writing black as an extreme example, while black display is made when a signal voltage of 0 V is written after threshold value correction, +α is added by the DS coupling. In order to remove+α, the mobility correcting time needs to be lengthened. Because the mobility correcting time needs to be lengthened as the gradation becomes lower, it is necessary to make the writing driving pulse WS have the waveform of the mechanism of changing a cutoff point for each gradation by blunting the falling edge of the writing driving pulse WS and thereby change the mobility correcting time for each signal voltage.

While the present invention has been described above using embodiments thereof, the technical scope of the present invention is not limited to a scope described in the foregoing embodiments. Various changes and improvements can be made to the foregoing embodiments without departing from the spirit of the invention, and forms obtained by adding such changes and improvements are also included in the technical scope of the present invention.

In addition, the foregoing embodiments do not limit inventions of claims, and not all combinations of features described in the embodiments are necessarily indispensable to solving section of the invention. The foregoing embodiments include inventions in various stages, and various inventions can be extracted by appropriately combining a plurality of disclosed constitutional requirements. Even when a few constitutional requirements are omitted from all the constitutional requirements disclosed in the embodiments, constitutions resulting from the omission of the few constitutional requirements can be extracted as inventions as long as an effect is obtained.

### <Examples of Modification of Pixel Circuit and Driving Timing>

For example a “duality principle” holds in circuit theory, and thus modifications can be made to the pixel circuit P from this viewpoint. In this case, though not shown in figures, while the pixel circuit P of the 5TR configuration shown in FIG. 8 includes the n-channel type drive transistor 121, a p-channel type drive transistor (hereinafter referred to as a p-type drive transistor 121p) is used to form a pixel circuit P. Accordingly, changes are made according to the duality principle, such for example as replacing the p-channel type light emission controlling transistor 122 with an n-channel type light emission controlling transistor (hereinafter referred to as an n-type light emission controlling transistor 122n) supplied with an active-H scanning driving pulse and reversing the polarity of the signal potential Vin of the video signal Vsig and the magnitude relation of power supply voltages.

As in the organic EL display device according to the basic example using the above-described n-type drive transistor, in an organic EL display device according to the modification example in which the drive transistor is changed to the p-type by applying the duality principle, a capacitive element 129 is connected to the gate terminal of the n-type light emission controlling transistor 122n and the source terminal of the p-type drive transistor 121p. Therefore a mobility correction can be made after the gate-to-source voltage Vgs of the p-type drive transistor 121p is widened in advance at the time of a start of the mobility correction. It is thus possible to compensate for a decrease in the gate-to-source voltage Vgs of the p-type drive transistor 121p due to the mobility correction.

It is to be noted that while the modification example described above is obtained by making changes to the 5TR configuration shown in FIG. 8 according to the “duality principle”, a method of changing the circuit is not limited to this, but may be applied to other than the 5TR configuration. Concepts of the present embodiment can be applied as long as the pixel circuit P and driving timing in which the sampling transistor 125 is set in an on state to retain information corresponding to the signal potential Vin in the storage capacitor 120 and then mobility correcting operation is performed while the sampling transistor 125 is held in the on state are provided.

What is claimed is:

1. A display device comprising:
a pixel array unit configured to include pixel circuits arranged in a form of a matrix, said pixel circuits each including a drive transistor for generating a driving current, an electrooptic element connected to an output terminal of said drive transistor, a storage capacitor for retaining information corresponding to a signal potential of a video signal, a sampling transistor for writing the information corresponding to said signal potential to said storage capacitor, and a capacitive element having one terminal connected to the output terminal of said drive transistor and having another terminal supplied with a pulse signal, said drive transistor generating the driving current based on the information retained in said storage capacitor and sending the driving current through said electrooptic element, whereby said electrooptic element emits light; and
a control unit configured to include a writing scanning unit for outputting, to said sampling transistor, a writing scanning pulse for performing line-sequential scanning of said pixel circuits by sequentially controlling said sampling transistor in a horizontal period and writing information corresponding to a signal potential of a video signal to each of storage capacitors in one row, and a horizontal driving unit for supplying a video signal for one row to a video signal line according to a signal potential writing operation of said sampling transistor;
wherein said control unit effects control to perform mobility correcting operation for, after said sampling transistor is set in a conducting state and the information corresponding to said signal potential is retained in said storage capacitor, adding an amount of correction for mobility of said drive transistor to the information written in said storage capacitor while said sampling transistor is held in the conducting state, the other terminal of said capacitive element is supplied with information corresponding to a pulse for starting said mobility correcting operation, and
the output terminal of said drive transistor is supplied via said capacitive element with transition information in a direction of increasing a potential difference between a control input terminal and the output terminal of said drive transistor.

2. The display device according to claim 1, further including a light emission controlling transistor for adjusting a duty ratio between an emission period and a non-emission period of said electrooptic element,
wherein a scanning driving pulse supplied to a control input terminal of said light emission controlling transistor is set as the pulse for starting said mobility correcting operation.

3. The display device according to claim 1, further including a light emission controlling transistor of one of an n-type and a p-type, for adjusting a duty ratio between an emission period and a non-emission period of said electrooptic element, said light emission controlling transistor being disposed on a power supply terminal side of said drive transistor of the other of said n-type and said p-type,
wherein the other terminal of said capacitive element is connected to a control input terminal of said light emission controlling transistor, and
a scanning driving pulse supplied to the control input terminal of said light emission controlling transistor is set as the pulse for starting said mobility correcting operation.

4. The display device according to claim 1,
wherein said control unit effects control to make said sampling transistor conduct in a time period in which a reference potential is supplied to said sampling transistor and perform threshold value correcting operation for retaining a voltage corresponding to a threshold voltage of said drive transistor in said storage capacitor, and after the threshold value correcting operation, said control unit effects control to perform the mobility correcting operation for adding the amount of correction for the mobility of said drive transistor to the information written in said storage capacitor.

5. The display device according to claim 4,
wherein said pixel circuits each include a switch transistor performing on/off operation on a basis of a control pulse at a time of said threshold value correcting operation and said mobility correcting operation by said control unit in addition to said drive transistor and said sampling transistor.

6. A pixel circuit comprising:
a drive transistor configured to generate a driving current;
an electrooptic element connected to an output terminal of said drive transistor;
a storage capacitor configured to retain information corresponding to a signal potential of a video signal;
a sampling transistor configured to write the information corresponding to said signal potential to said storage capacitor; and
a capacitive element configured to have one terminal connected to the output terminal of said drive transistor;
wherein another terminal of said capacitive element is supplied with transition information in a direction of increasing a potential difference between a control input terminal and the output terminal of said drive transistor, said transition information corresponding to a pulse for starting mobility correcting operation for adding an amount of correction for mobility of said drive transistor to the information written in said storage capacitor.

7. A driving method of a pixel circuit, said pixel circuit including a drive transistor for generating a driving current, an electrooptic element connected to an output terminal of said drive transistor, a storage capacitor for retaining information corresponding to a signal potential of a video signal, a sampling transistor for writing the information corresponding to said signal potential to said storage capacitor, and a capacitive element having one terminal connected to the output terminal of said drive transistor and having another terminal supplied with a pulse signal, said drive transistor generating the driving current based on the information retained in said storage capacitor and sending the driving current through said electrooptic element, whereby said electrooptic element emits light, said driving method comprising the step of:
when said sampling transistor is set in a conducting state and the information corresponding to said signal potential is retained in said storage capacitor, and then mobility correcting operation for adding an amount of correction for mobility of said drive transistor to the information written in said storage capacitor is performed while said sampling transistor is held in the conducting state, supplying information corresponding to a pulse for starting said mobility correcting operation to the other terminal of said capacitive element, whereby a potential difference between a control input terminal and the output terminal of said drive transistor is increased.

8. A display device comprising:
pixel array means for including pixel circuits arranged in a form of a matrix, said pixel circuits each including a drive transistor for generating a driving current, an electrooptic element connected to an output terminal of said drive transistor, a storage capacitor for retaining information corresponding to a signal potential of a video signal, a sampling transistor for writing the information corresponding to said signal potential to said storage capacitor, and a capacitive element having one terminal connected to the output terminal of said drive transistor and having another terminal supplied with a pulse signal, said drive transistor generating the driving current based on the information retained in said storage capacitor and sending the driving current through said electrooptic element, whereby said electrooptic element emits light; and
control means for including a writing scanning unit for outputting, to said sampling transistor, a writing scanning pulse for performing line-sequential scanning of said pixel circuits by sequentially controlling said sampling transistor in a horizontal period and writing information corresponding to a signal potential of a video signal to each of storage capacitors in one row, and a horizontal driving unit for supplying a video signal for one row to a video signal line according to a signal potential writing operation of said sampling transistor;
wherein said control means for effects control to perform mobility correcting operation for, after said sampling transistor is set in a conducting state and the information corresponding to said signal potential is retained in said storage capacitor, adding an amount of correction for mobility of said drive transistor to the information written in said storage capacitor while said sampling transistor is held in the conducting state,
the other terminal of said capacitive element is supplied with information corresponding to a pulse for starting said mobility correcting operation, and
the output terminal of said drive transistor is supplied via said capacitive element with transition information in a direction of increasing a potential difference between a control input terminal and the output terminal of said drive transistor.
